(19) United States
(12) Patent Application Publication
(10) Pub. No.: US 2019/0230569 A1
(43) Pub. Date: Jul. 25, 2019

(54) METHOD AND APPARATUS FOR SUPPORTING MOBILITY IN COMMUNICATION SYSTEM

(71) Applicant: ELECTRONICS AND TELECOMMUNICATIONS RESEARCH INSTITUTE, Daejeon (KR)

(72) Inventors: Jae Heung KIM, Daejeon (KR); Won Ik KIM, Daejeon (KR)

(21) Appl. No.: 16/316,800

(22) PCT Filed: Jul. 27, 2017
(86) PCT No.: PCT/KR2017/008119

§ 371 Date: Jan. 10, 2019

(30) Foreign Application Priority Data
Aug. 11, 2016 (KR) 10-2016-0102307
Aug. 22, 2016 (KR) 10-2016-0106239
Sep. 8, 2016 (KR) 10-2016-0115489
Oct. 21, 2016 (KR) 10-2016-0137743
Nov. 17, 2016 (KR) 10-2016-0153299
Dec. 19, 2016 (KR) 10-2016-0173527
Feb. 10, 2017 (KR) 10-2017-0018524
Mar. 16, 2017 (KR) 10-2017-0033114

(51) Int. Cl. H04W 36/30; H04W 36/08; H04W 36/32; H04W 24/10; H04W 88/16

(52) U.S. Cl. CPC H04W 36/30; H04W 36/08; H04W 88/16; H04W 24/10; H04W 36/32

(57) ABSTRACT

A method and an apparatus for supporting mobility in a communication system. An operation method for a mobile communication node includes: measuring channel quality between the mobile communication node and at least one adjacent communication node, on the basis of a signal received from the at least one adjacent communication node; transmitting a report message including information on the channel quality to a serving communication node connected to the mobile communication node; receiving, from the serving communication node, a response message including configuration information for a target communication node determined on the basis of the report message; and performing a connection establishment procedure with the target communication node indicated by the response message. Therefore, the performance of a communication system can be improved.

### BACKGROUND

### 1. Field of the Invention

The present invention relates to a technique for supporting mobility in a communication system, and more particularly, to a technology for supporting mobility in a communication system including an access network, an Xhaul network, and a core network.

### 2. Description of Related Art

A communication system (hereinafter, an ‘integrated communication system’) using a higher frequency band (e.g., a frequency band of 6 GHz or higher) than a frequency band (e.g., a frequency band lower below 6 GHz) of a long term evolution (LTE) based communication system (or, a LTE-A based communication system) is being considered for processing of soaring wireless data. The reception performance of a signal may deteriorate due to path loss of a radio wave and reflection of the radio wave in such the high frequency band (e.g., a frequency band of 6 GHz or higher), and a small base station supporting smaller cell coverage than that of a macro base station can be introduced into the integrated communication system in order to solve this problem. In the integrated communication system, the small base station may be connected to a core network using a wired backhaul link, in which case an initial investment cost, management cost, or the like of the integrated communication system may be increased.

Meanwhile, the integrated communication system may comprise the small base station performing all the functions of a communication protocol (e.g., a remote radio transmission and reception function, a baseband processing function), a plurality of transmission reception points (TRPs) performing the remote radio transmission and reception function among the functions of the communication protocol, a baseband unit (BBU) block performing the baseband processing function among the functions of the communication protocol, and the like.

The TRP may be a remote radio head (RRH), a radio unit (RU), or the like. The BBU block may include at least one BBU or at least one digital unit (DU). The BBU block may be referred to as a ‘BBU pool’, a ‘centralized BBU’, or the like. One BBU block may be connected to a plurality of TRPs, and perform the baseband processing function on signals received from the plurality of TRPs and signals to be transmitted to the plurality of TRPs.

In the integrated communication system, the small base station may be connected to the core network using a wireless backhaul link, and the TRP may be connected to the BBU block using a wireless fronthaul link. The investment and management costs of the integrated communication system comprised of the wireless links (e.g., wireless backhaul link, wireless fronthaul link) may be lower than those of the integrated communication system comprised of wired links (e.g., wired backhaul link, wired fronthaul link). Also, when the integrated communication system is configured with the wireless links, the efficiency of the integrated communication system can be enhanced. However, methods for supporting mobility of communication nodes (e.g., communication nodes located in automobiles, trains, aircraft (e.g., manned aircrafts or unmanned aircrafts such as drones), or the like) in the integrated communication system composed of the wireless links will be required.

### SUMMARY OF THE INVENTION

The present invention is directed to providing a method and an apparatus for supporting mobility of a communication node in an Xhaul network supporting communications between an access network and a core network.

An operation method of a mobile communication node, according to a first embodiment of the present invention to achieve the above-described purpose, may comprise measuring a channel quality between the mobile communication node and at least one adjacent communication node based on a signal received from the at least one adjacent communication node; transmitting a report message including information on the channel quality to a serving communication node connected to the mobile communication node; receiving, from the serving communication node, a response message including configuration information of a target communication node determined based on the report message; and performing a connection configuration procedure with the target communication node indicated by the response message. The mobile communication node, the serving communication node, the at least one adjacent communication node, and the target communication node may belong to the Xhaul network, and the target communication node may be one of the at least one adjacent communication node.

Here, the core network may comprise a serving gateway (S-GW), a packet data network (PDN) gateway (P-GW), and a mobility management entity (MME), the access network may include a terminal and a base station, the Xhaul network may include a plurality of communication nodes, the plurality of communication nodes may be connected via radio links, a first communication node of the plurality of communication nodes may be connected with at least one of the S-GW and the MME, and a second communication node of the plurality of communication nodes may be connected to the base station.

Here, the signal received from the at least one adjacent communication node may be a discovery signal, a synchronization signal, or a control signal.

Here, the report message may include configuration information of at least one candidate target communication node determined based on the information on the channel quality, and the target communication node may be determined among the at least one candidate target communication node.

Here, the configuration information of the target communication node may include information on a resource used for communications between the mobile communication node and the target communication node and an identifier of the target communication node.

Here, context information of the mobile communication node may be managed by the target communication node when the connection configuration procedure between the mobile communication node and the target communication node is completed, and the context information may include information on communication services requested by the mobile communication node, and an identifier and capability information of the mobile communication node.

The operation method may further comprise determining the target communication node based on the information on the channel quality when the response message is not received within a predetermined time; and performing the connection configuration procedure with the target communication node determined by the mobile communication node.

The operation method may further comprise performing a connection release procedure between the mobile communication node and the serving communication node, when the connection configuration procedure between the mobile communication node and the target communication node is completed.

An operation method of a serving communication node, according to a second embodiment of the present invention to achieve the above-described purpose, may comprise receiving, from the mobile communication node, a report message including information on a channel quality between the mobile communication node and at least one adjacent communication node; determining a target communication node based on the information on the channel quality; transmitting a mobility request message requesting mobility support of the mobile communication node to the target communication node; and transmitting a response message including configuration information of the target communication node to the mobile communication node, when a mobility approval message indicating approval of the mobility support of the mobile communication node is received from the target communication node. The mobile communication node, the serving communication node, the at least one adjacent communication node, and the target communication node may belong to the Xhaul network, and the target communication node may be one of the at least one adjacent communication node.

Here, the report message may include configuration information of at least one candidate target communication node determined based on the information on the channel quality, and the target communication node may be determined among the at least one candidate target communication node.

Here, the mobility request message may include information on communication services requested by the mobile communication node, and an identifier and capability information of the mobile communication node.

Here, the configuration information of the target communication node may include information on a resource used for communications between the mobile communication node and the target communication node and an identifier of the target communication node.

Here, the response message may instruct the mobile communication node to execute a handover from the serving communication node to the target communication node.

Here, the operation method may further comprise performing a connection release procedure between the mobile communication node and the serving communication node, when the connection configuration procedure between the mobile communication node and the target communication node is completed.

A mobile communication node according to a third embodiment of the present invention to achieve the above-described purpose may comprise a processor and a memory storing at least one instruction executed by the processor. The at least one instruction may be configured to measure a channel quality between the mobile communication node and at least one adjacent communication node based on a signal received from the at least one adjacent communication node; transmit a report message including information on the channel quality to a serving communication node connected to the mobile communication node; receive, from the serving communication node, a response message including configuration information of a target communication node determined based on the report message; and perform a connection configuration procedure with the target communication node indicated by the response message. The mobile communication node, the serving communication node, the at least one adjacent communication node, and the target communication node may belong to the Xhaul network, and the target communication node may be one of the at least one adjacent communication node.

Here, the report message may include configuration information of at least one candidate target communication node determined based on the information on the channel quality, and the target communication node may be determined among the at least one candidate target communication node.

Here, the configuration information of the target communication node may include information on a resource used for communications between the mobile communication node and the target communication node and an identifier of the target communication node.

Here, context information of the mobile communication node may be managed by the target communication node when the connection configuration procedure between the mobile communication node and the target communication node is completed, and the context information may include information on communication services requested by the mobile communication node, and an identifier and capability information of the mobile communication node.

Here, the at least one instruction may be further configured to determine the target communication node based on the information on the channel quality when the response message is not received within a predetermined time; and perform the connection configuration procedure with the target communication node determined by the mobile communication node.

Here, the at least one instruction may be further configured to perform a connection release procedure between the mobile communication node and the serving communication node, when the connection configuration procedure between the mobile communication node and the target communication node is completed.

### Advantageous Effects

According to the present invention, a communication system includes an access network, a core network, and an Xhaul network that supports communications between the access network and the core network, and mobility of a communication node (e.g., an automobile, a train, an aircraft (e.g., a manned aircraft or an unmanned aerial vehicle such as a drone) can be efficiently supported in the Xhaul network. For example, a handover operation between the communication nodes in the Xhaul network can be efficiently performed. Also, a signaling procedure for the mobility support operations (e.g., handover operation) in the Xhaul network can be performed so as to ensure the continuity of the communication service for the communication nodes having mobility. Accordingly, the performance of the communication system can be improved.

### BRIEF DESCRIPTION OF DRAWINGS

FIG. 1 is a conceptual diagram illustrating a first embodiment of a communication system;

FIG. 2 is a block diagram illustrating a first embodiment of a communication node constituting a communication system;

FIG. 3 is a conceptual diagram illustrating a second embodiment of a communication system;

FIG. 4 is a conceptual diagram illustrating a first embodiment of an integrated communication system;

FIG. 5 is a conceptual diagram illustrating a second embodiment of an integrated communication system;

FIG. 6 is a sequence chart illustrating a first embodiment of a mobility support method of an XDU in an integrated communication system;

FIG. 7 is a conceptual diagram illustrating a third embodiment of an integrated communication system;

FIG. 8 is a sequence chart illustrating a first embodiment of an access method in the integrated communication system;

FIG. 9 is a conceptual diagram illustrating a first embodiment of an Xhaul network;

FIG. 10 is a conceptual diagram illustrating a first embodiment of an XDU forming a plurality of sectors; and

FIG. 11 is a sequence chart illustrating a first embodiment of a mobility support method of a terminal in the integrated communication system.

### DETAILED DESCRIPTION OF THE INVENTION

While the present invention is susceptible to various modifications and alternative forms, specific embodiments are shown by way of example in the drawings and described in detail. It should be understood, however, that the description is not intended to limit the present invention to the specific embodiments, but, on the contrary, the present invention is to cover all modifications, equivalents, and alternatives that fall within the spirit and scope of the present invention.

Although the terms “first,” “second,” etc. may be used herein in reference to various elements, such elements should not be construed as limited by these terms. These terms are only used to distinguish one element from another. For example, a first element could be termed a second element, and a second element could be termed a first element, without departing from the scope of the present invention. The term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directed coupled” to another element, there are no intervening elements.

The terminology used herein is for the purpose of describing particular embodiments only and is not intended to be limiting of embodiments of the present invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, parts, and/or combinations thereof, but do not preclude the presence or addition of one or more other features, integers, steps, operations, elements, parts, and/or combinations thereof.

Unless otherwise defined, all terms (including technical and scientific terms) used herein have the same meaning as commonly understood by those of ordinary skill in the art to which the present invention pertains. It will be further understood that terms defined in commonly used dictionaries should be interpreted as having a meaning that is consistent with their meaning in the context of the related art and will not be interpreted in an idealized or overly formal sense unless expressly so defined herein.

Hereinafter, exemplary embodiments of the present invention will be described in greater detail with reference to the accompanying drawings. To facilitate overall understanding of the present invention, like numbers refer to like elements throughout the description of the drawings, and description of the same component will not be reiterated.

Hereinafter, a communication system to which embodiments according to the present disclosure will be described. However, the communication systems to which embodiments according to the present disclosure are applied are not restricted to what will be described below. That is, the embodiments according to the present disclosure may be applied to various communication systems. Here, the term ‘communication system’ may be used with the same meaning as the term ‘communication network’.

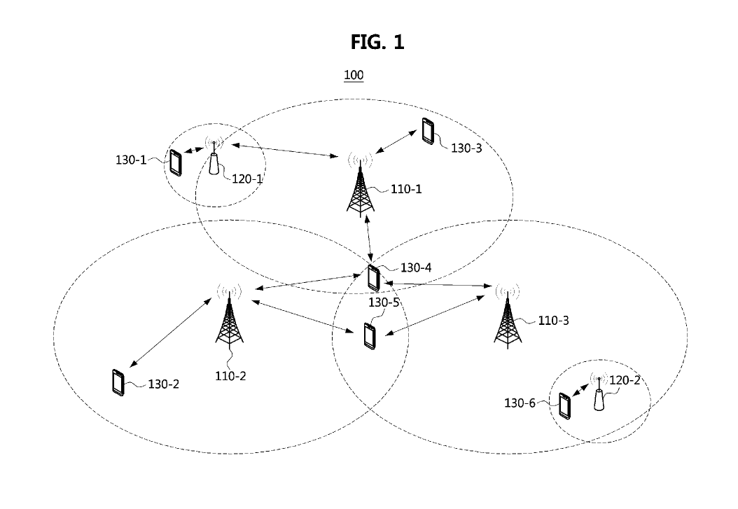

FIG. 1 is a conceptual diagram illustrating a first embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Also, the communication system 100 may comprise a core network (e.g., a serving gateway (S-GW), a packet data network (PDN) gateway (P-GW), a mobility management entity (MME), and the like).

The plurality of communication nodes may support 4th generation (4G) communication (e.g., long term evolution (LTE), LTE-advanced (LTE-A)), 5th generation (5G) communication, or the like. The 4G communication may be performed in a frequency band below 6 gigahertz (GHz), and the 5G communication may be performed in a frequency band above 6 GHz. For example, for the 4G and 5G communications, the plurality of communication nodes may support at least one communication protocol among a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, an orthogonal frequency division multiple access (OFDMA) based communication protocol, a cyclic prefix OFDM (CP-OFDM) based communication protocol, a discrete Fourier transform spread OFDM (DFT-s-OFDM) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, and a space division multiple access (SDMA) based communication protocol. Each of the plurality of communication nodes may have the following structure.

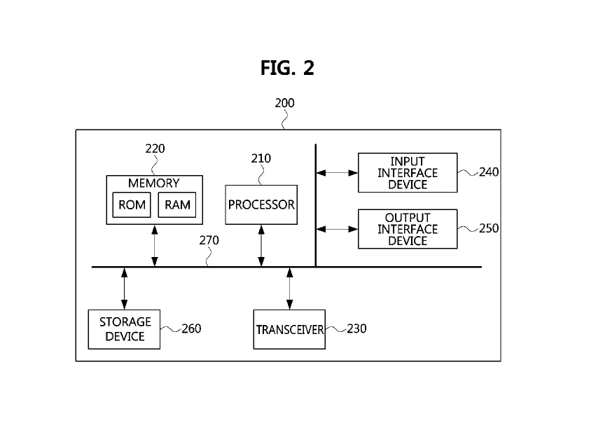

FIG. 2 is a block diagram illustrating a first embodiment of a communication node constituting a cellular communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, or the like. Also, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Also, each of the plurality of base stations 110-1, 110-2, 110-3, 120-1, and 120-2 may support a multi-input multi-output (MIMO) transmission (e.g., a single-user MIMO (SU-MIMO), a multi-user MIMO (MU-MIMO), a massive MIMO, or the like), a coordinated multipoint (CoMP) transmission, a carrier aggregation (CA) transmission, a transmission in unlicensed band, a device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2). For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Meanwhile, in a communication system, a base station may perform all functions (e.g., remote radio transmission and reception function, baseband processing function, and the like) according to a communication protocol. Alternatively, the remote radio transmission and reception function among all the functions according to the communication protocol may be performed by a transmission reception point (TRP), and the baseband processing function among all the functions according to the communication protocol may be performed by a baseband unit (BBU) block. The TRP may be a remote radio head (RRH), a radio unit (RU), a transmission point (TP), or the like. The BBU block may include at least one BBU or at least one digital unit (DU). The BBU block may be referred to as a ‘BBU pool’, a ‘centralized BBU’, or the like. The TRP may be connected to the BBU block via a wired fronthaul link or a wireless fronthaul link. A communication system composed of a backhaul link and a fronthaul link may be as follows. When a function-split technique of the communication protocol is applied, the TRP may selectively perform some functions of the BBU or some functions of a MAC/RLC layer.

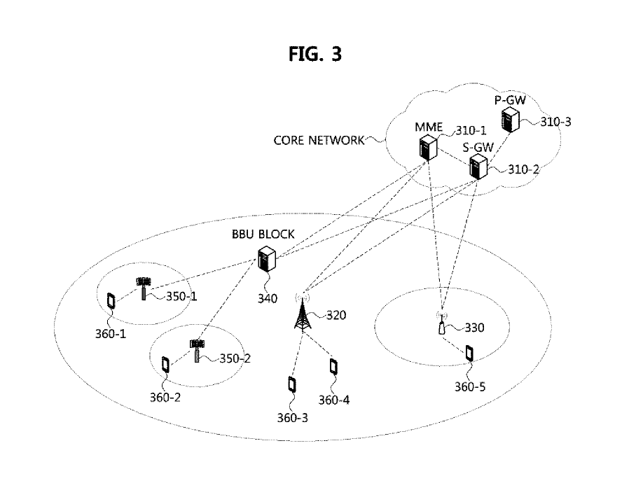

FIG. 3 is a conceptual diagram illustrating a second embodiment of a communication system.

Referring to FIG. 3, a communication system may include a core network and an access network. The core network may include an MME 310-1, an S-GW 310-2, a P-GW 310-3, and the like. The access network may include a macro base station 320, a small base station 330, TRPs 350-1 and 350-2, terminals 360-1, 360-2, 360-3, 360-4, and 360-5, and the like. The TRPs 350-1 and 350-2 may support the remote radio transmission and reception function among all the functions according to the communication protocol, and the baseband processing functions for the TRPs 350-1 and 350-2 may be performed by the BBU block 340. The BBU block 340 may belong to the access network or the core network. The communication nodes (e.g., MME, S-GW, P-GW, macro base station, small base station, TRPs, terminals, and BBU block) belonging to the communication system may be configured identically or similarly to the communication node 200 shown in FIG. 2.

The macro base station 320 may be connected to the core network (e.g., MME 310-1, S-GW 310-2) using a wired backhaul link or a wireless backhaul link, and provide communication services to the terminals 360-3 and 360-4 based on a communication protocol (e.g., 4G communication protocol, 5G communication protocol).

The small base station 330 may be connected to the core network (e.g., MME 310-1, S-GW 310-2) using a wired backhaul link or a wireless backhaul link, and may provide communication services to the terminal 360-5 based on a communication protocol (e.g., 4G communication protocol, 5G communication protocol).

The BBU block 340 may be located in the MME 310-1, the S-GW 310-2, or the macro base station 320. Alternatively, the BBU block 340 may be located independently of each the MME 310-1, the S-GW 310-2, and the macro base station 320. For example, the BBU block 340 may be configured as a logical function between the macro base station 320 and the MME 310-1 (or S-GW 310-2). The BBU block 340 may support the plurality of TRPs 350-1 and 350-2, and may be connected to each of the plurality of TRPs 350-1 and 350-2 using a wired fronthaul link or a wireless fronthaul link. That is, the link between the BBU block 340 and the TRPs 350-1 and 350-2 may be referred to as a ‘fronthaul link’.

The first TRP 350-1 may be connected to the BBU block 340 via a wired fronthaul link or a wireless fronthaul link, and provide communication services to the first terminal 360-1 based on a communication protocol (e.g., 4G communication protocol, 5G communication protocol). The second TRP 350-2 may be connected to the BBU block 340 via a wired fronthaul link or a wireless fronthaul link, and provide communication services to the second terminal 360-2 based on a communication protocol (e.g., 4G communication protocol, 5G communication protocol).

Next, mobility support methods of a communication node in a communication system will be described. Even when a method (e.g., transmission or reception of a signal) to be performed at a first communication node among communication nodes is described, a corresponding second communication node may perform a method (e.g., reception or transmission of the signal) corresponding to the method performed at the first communication node. That is, when an operation of a terminal is described, a corresponding base station may perform an operation corresponding to the operation of the terminal. Conversely, when an operation of the base station is described, the corresponding terminal may perform an operation corresponding to the operation of the base station.

In the embodiments to be described below, a communication system including an access network, an Xhaul network, and a core network may be referred to as an ‘integrated communication system’. The communication nodes (e.g., MME, S-GW, P-GW, BBU block, Xhaul distributed unit (XDU), Xhaul control unit (XCU), base station, TRP, terminal, and the like) may be configured identically or similarly to the communication node 200 shown in FIG. 2. The communication nodes belonging to the Xhaul network may be connected using an Xhaul link, and the Xhaul link may be a backhaul link or a fronthaul link.

Also, the S-GW of the integrated communication system may refer to an end communication node of the core network that exchanges packets (e.g., control information, data) with the base station, and the MME of the integrated communication system may refer to a communication node in the core network that performs control functions for a wireless access section (or, interface) of the terminal. Here, each of the backhaul link, the fronthaul link, the Xhaul link, the XDU, the XCU, the BBU block, the S-GW, and the MME may be referred to as a different term according to a function (e.g., function of the Xhaul network, function of the core network) of a communication protocol depending on a radio access technology (RAT).

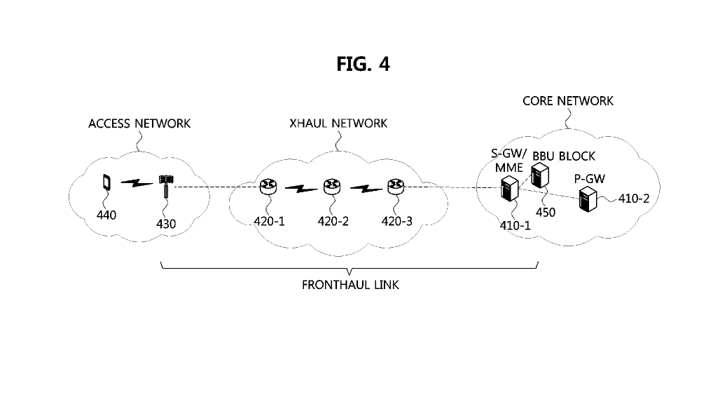

FIG. 4 is a conceptual diagram illustrating a first embodiment of an integrated communication system.

Referring to FIG. 4, the integrated communications system may include an access network, an Xhaul network, and a core network. The Xhaul network may be located between the access network and the core network, and may support communications between the access network and the core network. The communication nodes belonging to the integrated communication system may be configured to be the same as or similar to the communication node 200 shown in FIG. 2. The access network may include a TRP 430, a terminal 440, and the like. The Xhaul network may include a plurality of communication nodes 420-1, 420-2, and 420-3. The communication node constituting the Xhaul network may be referred to as an ‘XDU’. In the Xhaul network, the XDUs 420-1, 420-2, and 420-3 may be connected using wireless Xhaul links and may be connected based on a multi-hop scheme. The core network may include an S-GW/MME 410-1, a P-GW 410-2, and the like. The S-GW/MME 410-1 may refer to a communication node including an S-GW and an MME. The BBU block 450 may be located in the S-GW/MME 410-1 and may be connected to the third XDU 420-3 via a wired link.

The first XDU 420-1 of the Xhaul network may be connected to the TRP 430 using a wired link. Alternatively, the first XDU 420-1 may be integrated into the TRP 430. The second XDU 420-2 may be connected to each of the first XDU 420-1 and the third XDU 420-3 using a wireless link (e.g., wireless Xhaul link), and the third XDU 420-3 may be connected to an end communication node (e.g., the S-GW/MME 410-1) of the core network using a wired link. Among the plurality of XDUs 420-1, 420-2, and 420-3 of the Xhaul network, an XDU connected to an end communication node of the core network may be referred to as an ‘XDU aggregator’. That is, the third XDU 420-3 in the Xhaul network may be the XDU aggregator. The functions of the XDU aggregator may be performed by the S-GW/MME 410-1 in the core network.

The communications between the plurality of XDUs 420-1, 420-2 and 420-3 may be performed using a communication protocol for the Xhaul link (hereinafter, ‘Xhaul protocol’), which is different from an access protocol (e.g., a communication protocol used for communications between the terminal 440 and the TRP 430 (or, macro base station, small base station)). Packets to which the Xhaul protocol is applied may be transmitted to each of the core network and the access network through the Xhaul link. Here, the packets may indicate control information, data, and the like.

The TRP 430 may provide communication services to the terminal 440 using an access protocol (e.g., 4G communication protocol, 5G communication protocol), and may be connected to the first XDU 420-1 using a wired link. The TRP 430 may support a remote radio transmission and reception function among all the functions according to the communication protocol, and the baseband processing function for the TRP 430 may be performed in the BBU block 450. A link (e.g., “TRP 430-first XDU 420-1-second XDU 420-2-third XDU 420-3-BBU block 450 (or, SGW/MME 410-1)”) between the TRP 430 performing the remote radio transmission and reception function and the BBU block 450 performing the baseband processing function may be referred to as a ‘fronthaul link’. For example, the fronthaul link may be configured differently depending on the location of the BBU block 450 performing the baseband processing function.

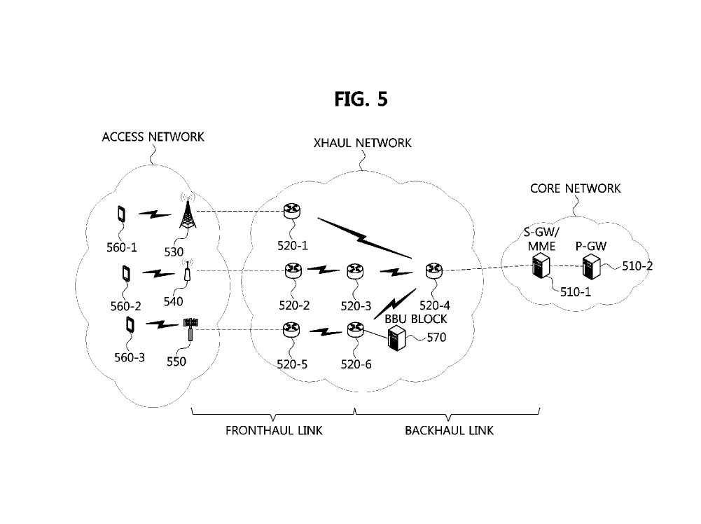

FIG. 5 is a conceptual diagram illustrating a second embodiment of an integrated communication system.

Referring to FIG. 5, the integrated communications system may include an access network, an Xhaul network, and a core network. The Xhaul network may be located between the access network and the core network, and may support communications between the access network and the core network. The communication nodes belonging to the integrated communication system may be configured to be the same as or similar to the communication node 200 shown in FIG. 2. The access network may include a macro base station 530, a small base station 540, a TRP 550, terminals 560-1, 560-2, and 560-3, and the like. The Xhaul network may include a plurality of communication nodes 520-1, 520-2, 520-3, 520-4, 520-5, and 520-6. The communication node constituting the Xhaul network may be referred to as an ‘XDU’. In the Xhaul network, the XDUs 520-1, 520-2, 520-3, 520-4, 520-5, and 520-6 may be connected using wireless Xhaul links and may be connected based on a multi-hop scheme. A BBU block 570 may be located in one XDU among the plurality of XDUs 520-1, 520-2, 520-3, 520-4, 520-5, and 520-6. For example, the BBU block 570 may be located in the sixth XDU 520-6. The core network may include an S-GW/MME 510-1, a P-GW 510-2, and the like. The S-GW/MME 510-1 may refer to a communication node including an S-GW and an MME.

The first XDU 520-1 of the Xhaul network may be connected to the macro base station 530 using a wired link, or may be integrated into the macro base station 530. The second XDU 520-2 of the Xhaul network may be connected to the small base station 540 using a wired link, or may be integrated into the small base station 540. The fifth XDU 520-5 of the Xhaul network may be connected to the TRP 550 using a wired link, or may be integrated into the TRP 550.

The fourth XDU 520-4 may be connected to an end communication node (e.g., the S-GW/MME 510-1) of the core network using a wired link. Among the plurality of XDUs 520-1, 520-2, 520-3, 520-4, 520-5, and 520-6, an XDU connected to an end communication node of the core network may be referred to as an ‘XDU aggregator’. That is, the fourth XDU 520-4 may be the XDU aggregator. The communications between the plurality of XDUs 520-1, 520-2, 520-3, 520-4, 520-5, and 520-6 may be performed using the Xhaul protocol. Packets (e.g., data, control information) to which the Xhaul protocol is applied may be transmitted to each of the core network and the access network via the Xhaul link.

The macro base station 530 may provide communication services to the first terminal 560-1 using an access protocol (e.g., 4G communication protocol, 5G communication protocol), and may be connected to the first XDU 520-1 via a wired link. The macro base station 530 may be connected to the core network via the Xhaul network, and a link of “macro base station 530-first XDU 520-1-fourth XDU 540-4-S-GW/MME 510-1” may be referred to as a ‘backhaul link’. The small base station 540 may provide communication services to the second terminal 560-2 using an access protocol (e.g., 4G communication protocol, 5G communication protocol), and may be connected to the second XDU 520-2 using a wired link. The small base station 540 may be connected to the core network via the Xhaul network, and a link of “small base station 540-second XDU 520-2-third XDU 540-3-fourth XDU 540-4-S-GW/MME 510-1” may be referred to as a ‘backhaul link’.

The TRP 550 may provide communication services to the third terminal 560-3 using an access protocol (e.g., 4G communication protocol, 5G communication protocol), and may be connected to the fifth XDU 520-5 using a wired link. The TRP 550 may support a remote radio transmission and reception function among all the functions according to the communication protocol, and the baseband processing function for the TRP 550 may be performed in the BBU block 570. A link (e.g., a link of “TRP 550-fifth XDU 520-5-BBU block 570 (or, sixth XDU 520-6)”) between the TRP 550 performing the remote radio transmission and reception function and the BBU block 570 performing the baseband processing function may be referred to as a ‘fronthaul link’, and a link (e.g., a link of “BBU block 570 (or, sixth XDU 520-6)-fourth XDU 520-4-S-GW/MME 510-1”) between the BBU block 570 and the S-GW/MME 510-1 may be referred to as a ‘backhaul link’. For example, the fronthaul link may be configured differently depending on the location of the BBU block 570 performing the baseband processing function.

Xhaul Network Based on Sidelink

The Xhaul network of FIG. 5 (or the Xhaul network of FIG. 4) may be configured using a sidelink (e.g., side channel) of an LTE-based communication system (or an LTE-A based communication system). The sidelink may refer to a link used for D2D communications in the LTE-based communication system. The resources for the Xhaul link in the Xhaul network may be configured with uplink resources or downlink resources of the LTE-based communication system (or the LTE-A based communication system).

When the sidelink of the LTE-based communication system (or the LTE-A based communication system) is used as the Xhaul link, the Xhaul link and the access link (e.g., a link between the terminal 560-1 and the macro base station 530) may be configured based on the same communication protocol, and thus a procedure for switching between the access link and the Xhaul link may not be necessary in the integrated communication system. For example, the fronthaul link between the TRP 550 and the BBU block 570 may be configured based on the communication protocol of the access link without the XDUs 520-5 and 520-6. That is, the TRP 550 may be directly connected to the BBU block 570 without the XDUs 520-5 and 520-6. Therefore, the fronthaul link and the backhaul link may be configured using sidelinks without XDUs.

Routing Procedure in Xhaul Network

In the Xhaul network of FIG. 5 (or the Xhaul network of FIG. 4), a routing procedure between the XDUs may be performed for transmission and reception of packets (e.g., data, control information) between the XDUs. Here, the routing procedure may be referred to as a ‘path set procedure’, a ‘path establishment procedure’, a ‘path mapping procedure’, a ‘path configuration procedure’, a ‘route set procedure’, a ‘route establishment procedure’, a ‘route mapping procedure’, a ‘route configuration procedure’, or the like. Also, the routing procedure may be referred to as a ‘link configuration procedure’, and the link configuration procedure may be referred to as a ‘link set procedure’, a ‘link establishment procedure’, a ‘link mapping procedure’, a ‘link configuration procedure’, or the like. Also, the routing procedure may be referred to as a ‘connection establishment procedure’, and the connection establishment procedure may be referred to as a ‘connection set procedure’, a ‘connection establishment procedure’, a ‘connection mapping procedure’, a ‘connection configuration procedure’, or the like.

For the routing procedure between XDUs, a transmission control protocol (TCP)/internet protocol (IP), an Ethernet protocol, a user datagram protocol (UDP)/real time protocol (RTP), a multiprotocol label switching (MPLS) protocol, a general packet radio service (GPRS) tunneling (GTP) protocol, a Layer-2 (L2) switching protocol (e.g., a labeling-based protocol, a protocol using an additional header field), and the like may be used in a higher layer (e.g., a layer above a physical layer) of the Xhaul protocol. A path configuration completion state may be a state in which a packet can be transmitted and received through a source XDU, a destination XDU, a waypoint XDU, or the like indicated by a unique identifier (e.g., an identifier, an IP address, a label, etc. included in the header (or, control information)) of the protocol.

The routing procedure may be performed in the XDU or XCU. The XCU may perform a function of managing a topology of the Xhaul network, a function of managing packet transmission paths, or the like, and control the XDUs belonging to the Xhaul network. The XCU may be connected to a specific XDU (e.g., XDU aggregator) belonging to the Xhaul network. The function of the XCU may be performed by the MME of the core network. The XDU or XCU may perform a path management (PM) (or, routing management (RM)) function. For example, the XDU or XCU may control the routing procedure, a path release procedure (e.g., a connection release procedure, a link release procedure), a path activation procedure (e.g., a connection activation procedure, a link activation procedure), a path deactivation procedure (e.g., a connection deactivation procedure, a link deactivation procedures), and the like.

Also, the XCU may perform control functions of Xhaul network. For example, the XCU may exchange control information with the core network, signal control information to the XDUs belonging to the Xhaul network, and perform control functions for the XDUs belonging to the Xhaul network. The XCU may perform a mobility management (MM) function for mobility control and management, and a load control (LC) function for load control and management of the Xhaul links in the Xhaul network. Here, the XCU may include a PM function block (or, RM function block), a control function block, an MM function block, an LC function block, and the like.

The PM function block of the XCU may perform control and management operations for the paths of the Xhaul network. The path of the Xhaul network may be created or changed based on the control information transmitted from the XDU, the control function of the XCU, and the like. In addition, the PM function block of the XCU may identify whether or not the path is set for the XDUs belonging to the Xhaul network, and manage path configuration information, a routing table, a flow table, and the like.

The MM function block of the XCU may perform control operations related to the mobility of the XDUs belonging to the Xhaul network. In order to change the path according to the mobility of the XDU, the PM function block may change the path configuration information, the routing table, the flow table, and the like by interworking with the PM function block. Also, the MM function block of the XCU may perform configuration of measurement parameters for the XDU, configuration of report parameters for measurement results, or the like for controlling the mobility of the XDU.

In order to perform the PM function, the control function, the MM function, the LC function, and the like, the XCU may generate context information of each XDU belonging to the Xhaul network and manage the generated context information. The context information may be generated when the corresponding XDU is attached (or registered) in the Xhaul network, and may be deleted when the corresponding XDU is detached (or de-registered). The context information may include an identifier of the XDU, information on communication services requested by the XDU (e.g., information on communication services configured for the XDU), capability information of the XDU, and the like.

A mobility support function (e.g., the MM function of the XCU) in the Xhaul network may be used for XDUs located in mobile devices (e.g., automobiles, trains, aircrafts (e.g., manned aircrafts or unmanned aerial vehicles such as drone)), and provide service continuity for the travelling XDUs. Also, the mobility support function in the Xhaul network may also be applicable to a beam change procedure (or, sector change procedure) between XDUs (or, of an XDU) having different service areas in an intra-frequency environment (or inter-frequency environment).

Definitions of XDUs in Xhaul Network

The higher transmission reliability may be required on the Xhaul link than the access link (e.g., an access channel) between the terminal and the base station. Therefore, a mobility support function without communication service interruption or packet loss will be needed for the Xhaul link. The mobility support function may be a handover function. For the mobility support function to provide continuity of communication services in the Xhaul network, the XDUs may be classified as shown in Table 1 based on connection levels with the mobile XDU, transmission and reception level of packets, and the like. Here, the mobile XDU may be an XDU located in a mobile device having mobility.

TABLE 1

| Type | Characteristics |
|---|---|
| Serving | A serving XDU may receive a non-contention-based resource |
| XDU | request message from a mobile XDU. The mobile XDU may |
| | receive a packet from the serving XDU. |
| Linked | A linked XDU may periodically receive a non-contention- |
| XDU | based resource request message (or, a contention-based |
| | resource request message) from a mobile XDU. The mobile |
| | XDU may receive a packet from the linked XDU. |
| Candidate | The candidate linked XDU may receive a contention-based |
| linked | resource request message from a mobile XDU. The mobile |
| XDU | XDU may receive a packet from the candidate linked XDU. |
| Candidate | The candidate target XDU may be selected by a mobile XDU |
| target | based on configuration information of the candidate linked |
| XDU | XDU. The mobile XDU may report the selected candidate |
| | target XDU to a serving XDU (or, linked XDU, XCU). |

A serving XDU may be an XDU in a state in which path configuration for transmitting and receiving a packet (e.g., data, control information) with a mobile XDU is completed. The Serving XDU may perform a monitoring operation on radio channels of the mobile XDU, and may provide communication services to the mobile XDU. Accordingly, the mobile XDU may receive the required communication services from the serving XDU through packet transmission and reception procedures. The mobile XDU can always receive packets from the serving XDU. The mobile XDU may transmit a non-contention-based resource request message to the serving XDU using a preconfigured Xhaul link (e.g., data channel, control channel) between the mobile XDU and the serving XDU.

The linked (connected or routed) XDU may be an XDU in a state in which path configuration for transmitting and receiving a packet with a mobile XDU is completed. However, the linked XDU may not provide communication services to the mobile XDU. The mobile XDU may periodically transmit a non-contention-based resource request message to the linked XDU using a preconfigured Xhaul link (e.g., data channel, control channel) between the mobile XDU and the linked XDU. Also, the mobile XDU may receive packets from the linked XDU by performing periodic or aperiodic monitoring operations. Alternatively, the mobile XDU may receive packets from the linked XDU by continuously performing monitoring operations.

The candidate linked XDU may be an XDU in a state in which path configuration for transmitting and receiving a packet with a mobile XDU is not completed. Therefore, the mobile XDU may not receive a packet from the candidate linked XDU through a preconfigured Xhaul link (e.g., data channel, control channel). Here, the preconfigured Xhaul link may be a default Xhaul link (e.g., default data channel, default control channel). The mobile XDU may receive a discovery signal (or a synchronization signal), a common control signal, or the like from the candidate linked XDU, and obtain resource allocation information (e.g., resource configuration information) of a physical layer for a contention-based resource request operation to the corresponding linked XDU based on the received signal. The mobile XDU may transmit a contention-based resource request message to the candidate linked XDU based on the obtained resource allocation information.

The candidate target XDU may be selected by the mobile XDU. For example, the mobile XDU may receive information on candidate linked XDUs from the serving XDU (or, linked XDU, XCU). When the mobile XDU establishes an Xhaul link with a new XDU, in order to minimize a routing delay for the Xhaul link so that an interruption of communication services is prevented, the serving XDU (or, linked XDU, XCU) may transmit configuration information of the candidate linked XDUs to the mobile XDU. Here, the configuration information may include an identifier of the corresponding XDU, capability information of the corresponding XDU, information on communication services requested to the corresponding XDU (or, information on communication services provided by the corresponding XDU), and the like. The mobile XDU may perform a measurement procedure on at least one candidate linked XDU indicated by the configuration information of the candidate linked XDUs, and select a candidate target XDU based on results of the measurement. The mobile XDU may transmit configuration information of the candidate target XDU indicating the selected candidate target XDU to the serving XDU (or, linked XDU).

The functions of each of the serving XDU, the linked XDU, the candidate linked XDU, and the candidate target XDU may be performed by a serving base station, a linked base station, a candidate linked base station, and a candidate target base station belonging to the access network. The number of the respective serving XDUs, the respective linked XDUs, the respective candidate linked XDUs, and the respective candidate target XDUs in the Xhaul network may be at least one. For example, in the Xhaul network, the mobile XDU may be connected to at least one serving XDU, and at least one linked XDU for the mobile XDU may be configured. The mobile XDU may establish Xhaul links with a plurality of XDUs, and may perform transmission and reception procedures of packets based on properties of the XDUs. By establishing the plurality of Xhaul links for the mobile XDU in the Xhaul network, a mobility support function without packet loss can be provided.

A selection subject and a selection subject according to the property of the XDU in the Xhaul network may be as shown in Table 2 below. For example, the XCU may select a serving XDU, a linked XDU, etc., the serving XDU may select a serving XDU (e.g., another serving XDU), a linked XDU, a candidate linked XDU, etc., and the mobile XDU may select a candidate target XDU.

TABLE 2

| Selection | | | | | | |
|---|---|---|---|---|---|---|
| subject/ | | | | Candidate | Candidate | |
| Selection | | Serving | Linked | linked | target | |
| object | | XDU | XDU | XDU | XDU | Description |
| XCU | | ◯ | ◯ | X | — | |
| XDU | Serving | ◯ | ◯ | ◯ | — | When it is |
| | XDU | | | | | allowed for |
| | | | | | | the XCU to |
| | | | | | | select the |
| | | | | | | serving XDU |
| | | | | | | (or, linked |
| | | | | | | XDU), a |
| | | | | | | selection |
| | | | | | | result of |
| | | | | | | the serving |
| | | | | | | XDU may be |
| | | | | | | overridden |
| | | | | | | by the XCU. |
| | Mobile | X | X | X | ◯ | |
| | XDU | | | | | |

In the case that the XCU determines the serving XDU (or the linked XDU), the result of the measurement operation/procedure (e.g., the measurement operation/procedure for at least one candidate linked XDU indicated by the configuration information of the candidate linked XDUs) performed by the mobile XDU may be transmitted to the XCU. In the measurement procedure (or, measurement operation), a quality (e.g., received signal strength, latency, block error rate (BLER), etc.) of a radio channel between the mobile XDU and the candidate linked XDU may be measured. The XCU may determine the serving XDU (or, the linked XDU) based on the result of the measurement procedure performed by the mobile XDU, information collected by the XCU, and the like. For example, the XCU may determine an optimal serving XDU (or, linked XDU) for the mobile XDU by considering a latency, the number of hops of the Xhaul link, a channel capacity (e.g., traffic volume), a quality of service (QoS), a function-split level, a load status, or the like. The function-split level may indicate at least one layer supported by the corresponding communication node (e.g., XDU). For example, a function-split level 1 may indicate that the correspondent node supports layer-1 functionality, a function-split level 2 may indicate that the correspondent node supports layer-1 and layer-2 functionalities, and a function-split level 3 may indicate that the correspondent node supports layer-1, layer-2 and layer-3 functionalities. Also, the function-split level may indicate a case in which at least one function of the layer-1, layer-2, and layer-3 is partially supported. For example, a function-split level 1.5 may indicate that the correspondent node partially performs the functions of the layer-1.

The XCU may transmit a control message (e.g., control information) including configuration information of the determined serving XDU (or, linked XDU) to the mobile XDU via the current serving XDU (or, the currently linked XDU).

Also, similarly to the above-described determination procedure of serving XDU (or, linked XDU), the XCU may determine a candidate linked XDU and transmit a control message including configuration information of the determined candidate linked XDU to the mobile XDU via the serving XDU (or, linked XDU). The determination procedure of serving XDU, the determination procedure of linked XDU, and the determination procedure of candidate linked XDU may be performed by function blocks (e.g., the PM function block, the control function block, the MM function block, and the LC function block, etc.) included in the XCU. The determination procedure of serving XDU, the determination procedure of linked XDU, the determination procedure of candidate linked XDU, and the determination procedure of candidate target XDU may be performed based on preconfigured priorities (or, weights).

Meanwhile, the serving XDU may determine each of the serving XDU (i.e., another serving XDU), the linked XDU, and the candidate linked XDU based on results of the measurement procedure performed by the mobile XDU, information collected by the serving XDU, information collected by adjacent XDUs, information collected by the XCU, and the like. In order to respectively determine the optimal serving XDU, the optimal linked XDU, and the optimal candidate linked XDU, the serving XDU may continuously collect the necessary information and update the corresponding information. The serving XDU may transmit to the mobile XDU a control message including configuration information for each of the determined serving XDU, the determined linked XDU, and the determined candidate linked XDU.

In the Xhaul network, when the XCU finally determines the serving XDU, the linked XDU and the candidate linked XDU, the configuration information of each of the serving XDU, linked XDU and candidate linked XDU determined by the serving XDU may be transferred to the XCU instead of the mobile XDU. That is, the serving XDU may transmit XDU recommendation information (e.g., configuration information of each of the serving XDU, linked XDU, and candidate linked XDU determined by the serving XDU) to the XCU. The XCU may obtain the XDU recommendation information from the serving XDU, and finally determine each of the serving XDU, linked XDU, and candidate linked XDU based on the obtained XDU recommendation information, the information collected by the XCU, and the like. For example, each of the serving XDU, the linked XDU, and the candidate linked XDU determined by the serving XDU may be overridden by the XCU. The XCU may transmit to the mobile XDU via the serving XDU a control message including configuration information of each of the finally determined serving XDU, linked XDU, and candidate linked XDU.

The mobile XDU may receive the configuration information of the serving XDU (or, the linked XDU or the candidate linked XDU) from the serving XDU (or XCU). When the configuration information of the serving XDU (or, the linked XDU or the candidate linked XDU) is successfully received from the mobile XDU, the path configuration procedure between the mobile XDU and the serving XDU (or, the linked XDU) indicated by the received configuration information may be considered to be completed. When the path configuration procedure is completed, the context information of the mobile XDU may be stored and managed by the XCU (or, the serving XDU or a communication node supporting mobility support functions). The context information of the mobile XDU may include the identifier of the mobile XDU, the identifier of the serving XDU (e.g., the serving XDU to which the mobile XDU is connected), the capability of the mobile XDU, the information on communication services requested by the mobile XDU (or, information on communication services provided to the XDU), and the like.

The configuration information of the serving XDU may include at least one information element described in Table 3 below.

TABLE 3

| Information element | contents |
|---|---|
| Serving XDU related | Location of the serving XDU, identifier of the |
| information | serving XDU, address of the serving XDU, function- |
| | split level of the serving XDU, activation time point of the |
| | serving XDU |
| Information used for the | Resource allocation information for packet |
| mobile XDU to receive | reception, antenna configuration information, |
| packets from the serving | beamforming information, beam index, scheduling |
| XDU | identifier, function-split level, modulation and |
| | coding scheme (MCS) index (or, level), resource |
| | allocation information for feedback, resource |
| | allocation information for control channels (e.g., |
| | PDCCH, PUCCH), and the like |
| Information used for the | Resource allocation information for packet |
| mobile XDU to transmit | transmission, function-split level, MCS index, |
| packets to the serving XDU | resource allocation information for feedback, |
| | resource allocation information for control channels |
| | (e.g., PDCCH, PUCCH), and the like |

The configuration information of the linked XDU may include at least one information element described in Table 4 below.

TABLE 4

| Information element | contents |
|---|---|
| Linked XDU related | Location of the linked XDU, identifier of the linked |
| information | XDU, address of the linked XDU, function-split |
| | level of the linked XDU, activation time point of the |
| | linked XDU |
| Information used for the | Antenna configuration information, beamforming |
| mobile XDU to receive | information, beam index, scheduling identifier, |
| packets from the linked XDU | resource allocation information for control |
| | information, resource allocation information for |
| | control channels (e.g., PDCCH, PUCCH), function-split |
| | level, MCS index, and the like |
| Information used for the | Resource allocation information for control |
| mobile XDU to transmit | information, resource allocation information for |
| packets to the linked XDU | control channels (e.g., PDCCH, PUCCH), function- |
| | split level, MCS index, and the like |

The information on the activation time point of the serving XDU (or the linked XDU) may indicate a time when packets can be transmitted and received between the mobile XDU and the serving XDU (or the linked XDU). The activation point may be configured in a base time unit (e.g., radio frame, subframe, transmission time interval (TTI), slot, mini slot, symbol, or the like). The activation time point may indicate a specific time or a specific interval (e.g., window). Also, the configuration information of the XDU may further include a center frequency, latency information, a channel capacity (or traffic volume) information, load status information, and the like of the XDU.

When the Xhaul link is established between the mobile XDU and the serving XDU (or the linked XDU), the serving XDU (or the linked XDU) may exchange, with the mobile XDU, the configuration information of the candidate linked XDU, the configuration information of the candidate target XDU, selection criteria information of candidate linked XDU, selection criteria information of candidate target XDU, and the like. Each of the configuration information and selection criteria information exchanged between the serving XDU (or the linked XDU) and the mobile XDU may include at least one information element described in Table 5 below. Here, the mobile XDU may indicate an XDU located in a mobile device (e.g., a car, a train, an aircraft, etc.) having mobility, and the fixed XDU may indicate an XDU fixed in a specific location.

TABLE 5

| Information element | contents |
|---|---|
| Property information of the | may indicate whether the candidate linked XDU |
| candidate linked XDU (or, | (or, the candidate target XDU) is an XDU aggregator. |
| the candidate target XDU) | |
| | may indicate whether the candidate linked XDU |
| | (or, the candidate target XDU) is a fixed XDU or a |
| | mobile XDU. |
| Property information of the | Movement status information of the mobile XDU |
| mobile XDU | (e.g., location, movement speed, movement |
| | direction), function-split level of the mobile XDU, and |
| | the like |
| QoS information | QoS level (e.g., latency, BLER) |
| Load status information | Load status of Xhaul link (e.g., for each QoS based service) |

The ‘load status information’ in Table 5 may indicate a possibility of change in a channel capacity (e.g., increase or decrease of the channel capacity) of the candidate target XDU (or the candidate linked XDU). Also, the ‘load status information’ may indicate whether the candidate target XDU (or the candidate linked XDU) provides a large channel capacity.

Meanwhile, the XCU (or the serving XDU) may transmit to the mobile XDU configuration information of the candidate linked XDU, configuration information of a measurement procedure (e.g., a measurement procedure for selecting the candidate target XDU), configuration information of a reporting procedure for results of the measurement procedure, and the like. The results of the measurement procedure may include configuration information of the candidate target XDU selected by the mobile XDU. The mobile XDU may obtain the configuration information of the candidate linked XDU, the configuration information of the measuring procedure, the configuration information of the reporting procedure, etc. from the XCU (or the serving XDU), and may perform the measurement procedure and the reporting procedure based on the obtained configuration information. The mobile XDU may select the candidate target XDU among the candidate linked XDUs by performing the measurement procedure. Alternatively, the mobile XDU may select an XDU other than the candidate linked XDUs as the candidate target XDU in consideration of preconfigured selection criteria of candidate target XDU (or, selection criteria of serving XDU (or linked XDU)).

The mobile XDU may determine the candidate target XDU based on the configuration information obtained from the XCU (or the serving XDU), and may generate configuration information of the candidate target XDU. The mobile XDU may transmit to the serving XDU (or XCU) a control message including the results of the measurement procedure (e.g., configuration information of the candidate target XDU). Alternatively, the mobile XDU may generate a first control message including information on a radio channel quality of the XDU (e.g., the candidate target XDU) measured through the measurement procedure, the movement status information of the mobile XDU, the property information of the mobile XDU, etc. and may generate a second control message including configuration information of the candidate target XDU separately from the first control message. The mobile XDU may transmit each of the first control message and the second control message to the serving XDU (or XCU).

Each of the configuration information of the measurement procedure described above and the configuration information of the reporting procedure described above may be transmitted from the XCU (or serving XDU) to the mobile XDU, and may include at least one information element described in Table 6 below.

TABLE 6

| Information element | contents |
|---|---|
| Measurement objcet (or, | Candidate linked XDU or candidate target XDU |
| report parameter) information | |
| Measurement item (or, report | Radio channel quality, property information of the |
| item) information | mobile XDU, movement status information of the |
| | mobile XDU (e.g., location, movement speed, |
| | movement direction, distance between mobile XDU |
| | and the candidate target XDU, etc.) |
| Measurement criteria | Reference value of a radio channel quality according |
| information | to a QoS level (e.g., latency reference value, BLER |
| | reference value, channel capacity reference value, etc.) |
| Selection criteria information | Reference value of parameter used for selecting the |
| | candidate target XDU (or, serving XDU, linked XDU) |
| Configuration information | Measurement period, measurement interval (e.g., |
| for periodic (or, aperiodic) | measurement range), report period, triggering |
| measurement/reporting | conditions for aperiodic measurement/reporting |
| | procedure |

The ‘measurement object (or report parameter) information’ in Table 6 may indicate a candidate linked XDU, a candidate target XDU, and the like to be targeted in the measurement procedure (or the reporting procedure), and may be transmitted from the serving XDU to the mobile XDU when the Xhaul link between the serving XDU and the mobile XDU is configured. Also, the ‘measurement object (or report parameter) information’ in Table 6 may indicate an identifier, beam configuration information (e.g., beam index), center frequency, configuration information of reference signals, etc. of the candidate linked XDU (or the candidate target XDU). Here, the reference signal may refer to a ‘pilot signal’.

In the ‘measurement item information’ in Table 6, the radio channel quality may indicate a radio channel quality (e.g., received signal strength, latency, BLER) of each of the serving XDU, candidate target XDU and candidate linked XDU. The location of the mobile XDU in the ‘measurement item information’ in Table 6 may be determined using a positioning system (e.g., a positioning system based satellite signals, or terrestrial or wireless local area network (WLAN) signals) or using a positioning algorithm based on a separate reference signal. The XCU (or serving XDU) may use the location of the mobile XDU to estimate the distance (e.g., positional difference) between the mobile XDU and the serving XDU (or the linked XDU, candidate linked XDU, candidate target XDU). The location of the mobile XDU and the distance between the mobile XDU and the serving XDU (or linked XDU, candidate linked XDU, candidate target XDU) may be expressed as an absolute value. Alternatively, the location of the mobile XDU and the distance between the mobile XDU and the serving XDU (or linked XDU, candidate linked XDU, candidate target XDU) may be expressed as a relative value to a specific point (or, reference value, previous value).

In the ‘measurement item information’ in Table 6, the movement status information of the mobile XDU may be periodically reported. Alternatively, the movement status information of the mobile XDU may be reported when the movement direction of the mobile XDU is changed. The movement direction of the mobile XDU may be expressed in a clockwise manner (e.g., 1 o'clock, 6 o'clock, or the like). Alternatively, when the mobile XDU moves along a specific path (e.g., a road, a waterway, an orbit, etc.), the movement direction of the mobile XDU may be expressed by a direction (e.g., east-north direction, south-west direction, etc.) or an angle (e.g., 45 degrees, 90 degrees, etc.) with reference to a departure point, a waypoint, or a destination point. In the Xhaul network, indexes respectively mapped to movement directions of the mobile XDU may be configured in advance, and the preconfigured indexes may be shared by all the communication nodes belonging to the Xhaul network. In this case, an index corresponding to the specific movement direction of the mobile XDU may be reported to the XCU (or the serving XDU) based on the preconfigured mapping relationship.

Meanwhile, the mobile XDU may perform the measurement procedure and the reporting procedure based on the ‘configuration information for periodic (aperiodic) measurement/reporting’ in Table 6. In the triggering conditions for periodic (or, aperiodic) measurement/reporting of Table 6, the triggering condition for the aperiodic measurement/reporting procedure may be a reference value for a difference in the channel quality between the candidate target XDU (or the candidate linked XDU) and the serving XDU, a BLER reference value of the serving XDU, etc. in the measurement period (or, measurement interval). For example, if the difference in channel quality between the candidate target XDU (or the candidate linked XDU) and the serving XDU or the BLER of the serving XDU is equal to or greater than the preset reference value, the mobile XDU may perform the aperiodic measurement/reporting procedure. Here, the reference value may be referred to as a ‘threshold value’.

The mobile XDU may identify a candidate linked XDU satisfying the selection criteria of candidate target XDU by performing the measurement procedure for the candidate linked XDUs, and determine the candidate linked XDU satisfying the selection criteria of candidate target XDU as the candidate target XDU. The mobile XDU may transmit a packet (e.g., control message, control information) containing the result of the measurement procedure (e.g., configuration information of the candidate target XDU) to the serving XDU (or, linked XDU, XCU). The generation procedure of the configuration information of the candidate target XDU and triggering for the determination procedure of target XDU may be performed by the mobile XDU.

The XCU (or serving XDU) may determine a target XDU based on the results of the measurement procedure performed by the mobile XDU. Also, the XCU (or serving XDU) may determine a target XDU in consideration of a state of the Xhaul network. Thus, the XCU (or serving XDU) may determine an XDU other than the candidate target XDU indicated by the results of the measurement procedure performed by the mobile XDU to be a target XDU. The target XDU may be an XDU to be changed from the candidate linked XDU or the candidate target XDU to a serving XDU (or a linked XDU). The XCU (or serving XDU) may generate a control message including configuration information of the target XDU and may transmit the generated control message to the mobile XDU. The configuration information of the target XDU may include at least one of configuration information for a serving XDU and configuration information for a linked XDU. If the configuration information of the target XDU is generated in the XCU, the control message including the configuration information of the target XDU may be transmitted to the mobile XDU via the serving XDU (or the linked XDU). The mobile XDU may receive the control message including the control information of the target XDU from the serving XDU (or the linked XDU), and perform a path configuration procedure with the target XDU based on the configuration information of the target XDU indicated by the received control message.

Next, a mobility support method of a mobile XDU in an integrated communication system (e.g., the integrated communication system shown in FIG. 4 or 5) will be described. The mobility support method may be referred to as a ‘handover method’.

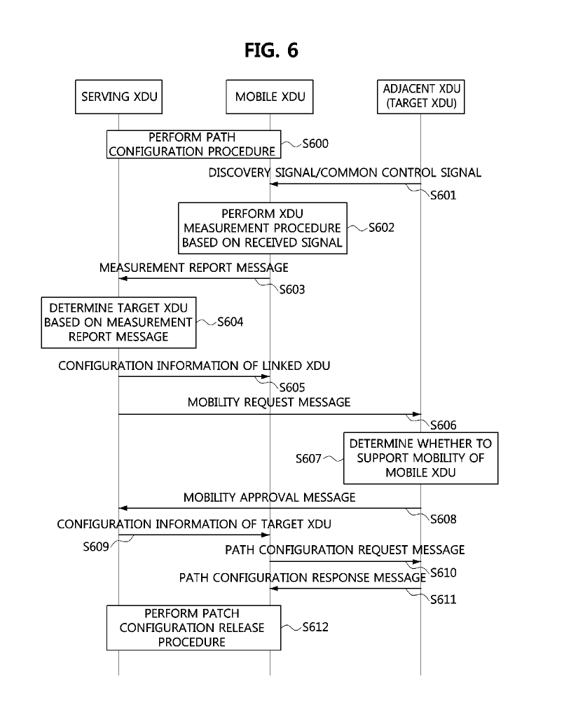

FIG. 6 is a sequence chart illustrating a first embodiment of a mobility support method of an XDU in an integrated communication system.

Referring to FIG. 6, the serving XDU may indicate the sixth XDU 520-6 of FIG. 5 and the mobile XDU may indicate the fifth XDU 520-5 of FIG. 5. In the case that the mobile XDU is the fifth XDU 520-5 of FIG. 5, the mobile XDU may be configured to be integrated into the TRP 550, or may be configured independently of the TRP 550. Also, the fifth XDU 520-5 and the TRP 550 may be located in a mobile device (e.g., a car, a train, an aircraft, etc.) having mobility. The adjacent XDU (or target XDU) may indicate the second XDU 520-2, the third XDU 520-3, etc. of FIG. 5. The mobility support method of the XDU described below may be used to support the mobility of the terminal in the access network. In this case, the operation of each of the serving XDU, the adjacent XDU, and the mobile XDU may be performed by each of the serving base station, the adjacent base station, and the terminal of the access network.

A path configuration procedure may be performed between the serving XDU and the mobile XDU (S600). The path configuration procedure may be referred to as a ‘link configuration (or establishment) procedure’, ‘connection configuration (or establishment) procedure’, or the like. In the path configuration procedure, the serving XDU may generate a message including configuration information of the candidate linked XDU or the measurement candidate XDU, and may transmit the generated message to the mobile XDU. Here, the message may be a frame, a signal, a packet, or the like. When the candidate linked XDU (e.g., measurement candidate XDU) is determined by the XCU, the serving XDU may obtain the configuration information of the candidate linked XDU (or, configuration information of the measurement candidate XDU) from the XCU, generate a message including the configuration information of the candidate linked XDU (or, configuration information of the measurement candidate XDU), and transmit the generated message to the mobile XDU. The measurement candidate XDU may indicate the XDU targeted in the measurement procedure of S602.

The configuration information of the candidate linked XDU may include at least one of information elements described in Table 7 below. The configuration information of the measurement candidate XDU may include the information elements described in Table 7 below (e.g., property information of the candidate linked XDU, physical layer information of the candidate linked XDU), measurement cycle for the XDU, measurement reporting cycle for the XDU, XDU measurement events (e.g., selection criteria information of candidate target XDU listed in Table 6), and the like.

TABLE 7

| Information element | contents |
|---|---|
| Property information of the | may indicate whether the candidate linked XDU is |
| candidate linked XDU | an XDU aggregator. |
| | may indicate whether the candidate linked XDU is a |
| | fixed XDU or a mobile XDU. |
| | Function-split level of the candidate linked XDU |
| Physical layer information of | Identifier, center frequency, resource allocation |
| the candidate linked XDU | information of physical layer (e.g., resource |
| | allocation information of reference signals), beam |
| | configuration information (e.g., beamforming |
| | information, beam index, beam width, etc.) |
| Latency information | Latency between the candidate linked XDU and the XDU |
| | aggregator |
| Channel capacity information | Channel capacity of the candidate linked XDU |
| QoS information | QoS level (e.g., latency, BLER) |
| Load status information | Load status information of Xhaul link (e.g., |
| | reference value of channel capacity required for each |
| | QoS-based service) |

In the path configuration procedure, the mobile XDU may receive the message including the configuration information of the candidate linked XDU (e.g., the configuration information of the measurement candidate XDU) from the serving XDU, and may identify the configuration information of the candidate linked XDU (e.g., the configuration information of the measurement candidate XDU) based on the received message. The mobile XDU may perform the measurement procedure for the XDU (e.g., adjacent XDU) indicated by the configuration information of the candidate linked XDU (e.g., the configuration information of the measurement candidate XDU).

Meanwhile, the XDU (e.g., serving XDU, linked XDU, adjacent XDU, etc.) belonging to the Xhaul network may transmit discovery signals (or a synchronization signals), common control signals, and the like (S601). The discovery signal and the common control signal may be transmitted periodically or aperiodically. The discovery signal may include an identifier of the XDU, a system bandwidth of the XDU, information on resources through which the common control signals are transmitted, and the like. Accordingly, the communication node that receives the discovery signal (or, the synchronization signal) may obtain or identify the corresponding information elements (e.g., the identifier of the XDU, the system bandwidth of the XDU, resource information, etc.) by detecting a sequence (e.g., a sequence set) constituting the discovery signal (or the synchronization signal). The common control signal may include the identifier of the XDU, the system bandwidth of the XDU, control information (e.g., system information), and the like. Alternatively, the common control signal may include indexes respectively indicating the identifier of the XDU, the system bandwidth of the XDU, and the control information. Therefore, the communication node which receives the common control signal may directly obtain the identifier of the XDU, the system bandwidth of the XDU, the control information, etc. from the common control signal, or may obtain the identifier of the XDU, the system bandwidth of the XDU, the control information, etc. based on the indexes included in the common control signal.

The control information may further include location information of the XDU. The location information of the XDU may include location information based on the positioning system (e.g., global positioning system (GPS) position information), location information based on a navigation system (e.g., intersections, bridges, junction points, tunnels, particular buildings, etc.), information on a relative location to a specific location, address information, and the like. The location information of the XDU may be transmitted through another signal instead of the common control signal.

The control information may further include capability information of the XDU. The capability information of the XDU may include property information of the XDU, a function-split level of the XDU, ON/OFF mode support information of the XDU, and the like. The location information of the XDU may be included in the capacity information of the XDU instead of the control information. The property information of the XDU may indicate whether the corresponding XDU is an XDU aggregator. Also, the property information of the XDU may indicate whether the corresponding XDU is a fixed XDU or a mobile XDU. The function-split level of the XDU may indicate layers supported by the XDU (e.g., layer 1, layer 2, layer 3, or some functions of each layer). The ON/OFF mode support information of the XDU may indicate whether the corresponding XDU supports the ON/OFF mode. When the XDU supports the ON/OFF mode, the XDU may operate in an ON mode (e.g., active mode) or an OFF mode (e.g., inactive mode) according to a preconfigured periodicity.

The mobile XDU may perform the XDU measurement procedure based on the received discovery signal and common control signal (S602). For example, the mobile XDU may receive a discovery signal, a control signal, etc. from at least one adjacent XDU and may measure at least one radio channel quality between the mobile XDU and at least one adjacent XDU based on the received signal. The mobile XDU may determine whether a measured channel quality satisfies the selection criteria of candidate target XDU (or, selection criteria of serving XDU, selection criteria of linked XDU). For example, if the measured radio channel quality is equal to or greater than a preset threshold value, the mobile XDU may determine that the measured radio channel quality satisfies the selection criteria of candidate target XDU. The mobile XDU may determine the adjacent candidate XDU having the radio channel quality satisfying the selection criteria of candidate target XDU as a candidate target XDU.

The mobile XDU may generate a measurement report message including information of the measured radio channel quality (e.g., received signal strength, latency, BLER) and may transmit the generated measurement report message to the serving XDU (S603). The measurement report message may be transmitted and received via the Xhaul link established between the serving XDU and the mobile XDU. The measurement report message may further include configuration information of at least one candidate target XDU determined by the mobile XDU. Also, if the result of the XDU measurement procedure satisfies the selection criteria of candidate target XDU, the mobile XDU may transmit a message triggering a change of the XDU to the serving XDU. The message triggering the change of the XDU may be transmitted to the serving XDU separately from the measurement report message. The change of the XDU may mean adding, changing or deleting a serving XDU (or a linked XDU). For example, the message triggering a change of serving XDU (or, linked XDU) may indicate a change of “connection XDU→serving XDU”, “serving XDU→linked XDU”, “target XDU→serving XDU”, “target XDU→linked XDU”, or the like. Alternatively, triggering of the XDU change may be performed by the serving XDU (or, XCU). For example, the serving XDU (or XCU) may trigger the XDU change based on the measurement report message received from the mobile XDU.

Meanwhile, the serving XDU may receive the measurement report message from the mobile XDU, and determine an optimal target XDU in consideration of the information included in the measurement report message, the information of the Xhaul network, the configuration information of the candidate linked XDU, and the like (S604). Also, the serving XDU may determine whether to change the XDU based on the information included in the measurement report message. Alternatively, if the determination procedure of the target XDU and the determination procedure of the XDU change are performed in the XCU, the serving XDU may transmit the measurement report message of the mobile XDU to the XCU. The XCU may receive the measurement report message of the mobile XDU from the serving XDU, and determine an optimal target XDU in consideration of the information included in the measurement report message, the information of the Xhaul network, the configuration information of the candidate linked XDU, and the like. Also, the XCU may determine whether to change the XDU based on the information included in the measurement report message.

Also, the serving XDU (or XCU) may determine a linked XDU based on the information included in the measurement report message of the mobile XDU, and may transmit a message including configuration information of the linked XDU to the mobile XDU (S605). If the linked XDU is determined by the XCU, the XCU may transmit a message including configuration information of the linked XDU to the mobile XDU via the serving XDU. The mobile XDU may receive the message including the configuration information of the linked XDU from the serving XDU (or XCU), and identify the configuration information of the linked XDU based on the received message. Here, the step S605 may be performed selectively.

If an adjacent XDU is determined to be the target XDU, the serving XDU (or XCU) may transmit a mobility request message (e.g., a handover request message) requesting a support of mobility for the mobile XDU to the adjacent XDU (i.e., target XDU) (S606). The mobility request message may request an XDU change as well as the mobility support for the mobile XDU.

The mobility request message may include the identifier of the mobile XDU, the capability of the mobile XDU, the information on communication services requested by the mobile XDU (or the information on communication services provided to the mobile XDU), and the like. The adjacent XDU may receive the mobility request message from the serving XDU (or XCU), and determine whether to support the mobility of the mobile XDU based on the mobility request message (e.g., whether to approve the handover of the mobile XDU) (S607). Also, the adjacent XDU may determine whether to perform the XDU change procedure.

If the mobility of the mobile XDU is determined to be supported in the adjacent XDU (e.g., if the handover of the mobile XDU is accepted), the adjacent XDU may transmit a mobility approval message (e.g., handover approval message) indicating that the mobility of the mobile XDU is supported to the serving XDU (S608). Also, the mobility approval message may indicate that the XDU change procedure is performed in the adjacent XDU. The mobility approval message may include control information necessary for the mobility support of the mobile XDU, control information necessary for the XDU change procedure, and the like. When the mobility approval message is received from the adjacent XDU, the serving XDU (or XCU) may determine that the mobility of the mobile XDU is supported in the adjacent XDU. Alternatively, the serving XDU (or XCU) may determine that the XDU change procedure is performed in the adjacent XDU. The steps S606 to S608 may be selectively performed in consideration of the state of the Xhaul network.

The serving XDU (or XCU) may generate a message including configuration information of the target XDU, and may transmit the generated message to the mobile XDU (S609). The configuration information of the target XDU may include at least one information element among the information elements included in the configuration information of serving XDU and the configuration information of linked XDU. Also, the message including the configuration information of the target XDU may indicate the XDU change. The mobile XDU may receive the message including the configuration information of the target XDU from the serving XDU (or XCU) and may identify that the adjacent XDU is the target XDU based on the received message. Accordingly, the mobile XDU may transmit a path configuration request message (e.g., an access request message) to the adjacent XDUs to request path configuration (S610).

In order to increase the efficiency of the step S610, a plurality of beams may be allocated to the mobile XDU. For example, the serving XDU may transmit a message (e.g., the message of the step S605 or S609) including allocation information of a plurality of beams (e.g., resource allocation information of a plurality of random access preambles) to the mobile XDU. The mobile XDU may transmit a path configuration request message to adjacent XDUs using the plurality of beams indicated by the message received from the serving XDU. Alternatively, the mobile XDU may use a plurality of beams to transmit the path configuration request message to adjacent XDUs even if the plurality of beams are not allocated to the mobile XDU. Also, the adjacent XDU may allocate a plurality of beams to the mobile XDU. In this case, the mobile XDU may use the plurality of beams to transmit messages, data, and the like related to a mobility support procedure (e.g., handover procedure) to adjacent XDUs.

When the path configuration request message is received from the mobile XDU, the adjacent XDU may determine a path between the adjacent XDU and the mobile XDU is requested to be configured, and transmit to the mobile XDU a path configuration response message (e.g., an access response message) in response to the path configuration request message (S611). The path configuration response message may include the configuration information of the candidate linked XDU, the configuration information of the measurement candidate XDU, the selection criteria information of the candidate target XDU, the selection criteria information of the serving XDU, the selection criteria information of the linked XDU, and the like. The configuration information and selection criteria information included in the path configuration response message may be generated by the serving XDU or XCU. If the steps S610 and S611 are successfully performed, a path between the mobile XDU and the adjacent XDU may be established.

Meanwhile, even if the path configuration request message is not received from the mobile XDU, the adjacent XDU may transmit the path configuration response message to the mobile XDU. For example, if the steps S606 to S608 have been performed between the serving XDU and the adjacent XDU, the adjacent XDU may transmit a path configuration response message to the mobile XDU without receiving the path configuration request message. When the path configuration procedure between the mobile XDU and the adjacent XDU is completed (e.g., after the step S611), a path configuration release procedure (e.g., a link release procedure, a connection release procedure) between the mobile XDU and the serving XDU may be performed (S612).

On the other hand, in the step S609, if the mobile XDU does not receive the message including the configuration information of the target XDU from the serving XDU, the path configuration procedure between the mobile XDU and the adjacent XDU (i.e., the target XDU) may not be completed. In order to solve this problem, when a path configuration request message (i.e., the path configuration request message transmitted and received in the step S610) is not received from the mobile XDU within a predetermined time, the adjacent XDU may transmit to the mobile XDU an initiation request message instructing to initiate the path configuration procedure between the mobile XDU and the adjacent XDU. The predetermined time (e.g., timer) may be set to T360. T360 may start at a reception time of the mobility request message at the step S606 or at a transmission time of the mobility approval message at the step S608. If the path configuration request message is received at the adjacent XDU before T360 has elapsed, a counting procedure of T360 may be stopped.

The initiation request message may include information requesting reception of a message of the adjacent XDU, scheduling information of radio resources for communication between the mobile XDU and the adjacent XDU, a paging message (e.g., paging message defined in the LTE-based communication system) related information, reception indication information indicating presence of data, uplink grant information, and the like. Also, the adjacent XDU may transmit the scheduling information of radio resources for communication between the mobile XDU and the adjacent XDU to the serving XDU through the step S608. In this case, the serving XDU may transmit the scheduling information of radio resources for communication between the mobile XDU and the adjacent XDU to the mobile XDU. The scheduling information of radio resources for the communication between the mobile XDU and the adjacent XDU may be not scheduling information of radio resources for an access procedure (e.g., radio resources for a random access procedure in the LTE-based communication system), but scheduling information of radio resources for transmission of packets (e.g., data, control information).

Also, the initiation request message may further include the identifier of the mobile XDU. The identifier of the mobile XDU may be a unique identifier that identifies the mobile XDU in a local area (e.g., cell, sector, etc.) supported by the target XDU. The adjacent XDU may obtain the identifier of the mobile XDU from the serving XDU in the step S606. Alternatively, the adjacent XDU may configure an identifier of the mobile XDU or a scheduling identifier (e.g., a cell-radio network temporary identifier (C-RNTI) in the LTE-based communication system) in the adjacent XDU, and notify the identifier of the mobile XDU (or, the scheduling identifier in the adjacent XDU) to the serving XDU in the step S608.

On the other hand, if the message including the configuration information of the target XDU in the step S609 is not received within a preconfigured time (e.g., T370) from the transmission time of the measurement report message of the step S603, the mobile XDU may perform a monitoring operation to receive an initiation request message of the mobile XDU. Here, the initiation request message of the adjacent XDU may be a message for the adjacent XDU to instruct the mobile XDU to receive packets or a signaling message (or packet data) for the mobile XDU. T370 may be counted from the transmission time of the measurement report message in the step S603, and the counting procedure for T370 may be stopped if the initiation request message of the adjacent XDU is received.

The mobile XDU may receive the initiation request message by performing the monitoring operation, and may obtain, when the identifier of the mobile XDU (or, the scheduling identifier configured for the mobile XDU) is present in the received initiation request message, the information requesting reception of a message of the adjacent XDU, the scheduling information of radio resources for communication between the mobile XDU and the adjacent XDU, the paging message related information, the reception indication information indicating presence of data, uplink grant information, and the like from the received initiation request message. The mobile XDU may perform transmission and reception procedures of packets with the adjacent XDU based on the information included in the initiation request message, and may perform a path configuration procedure between the mobile XDU and the adjacent XDU (e.g., the steps S610 and S611).

Meanwhile, if the quality of the radio channel of the adjacent XDU is less than or equal to a preset threshold value, the mobile XDU may not perform the monitoring operation for receiving the initiation request message of the adjacent XDU. If the message including the configuration information of the target XDU in the step S609 is not received within the preset T350, if the initiation request message of the adjacent XDU is not received within a preset T380 through the monitoring operation performed after the end of the preset T370, or if the quality of the radio channel of the adjacent XDU is less than or equal to a preset threshold value, the mobile XDU may determine that the mobility support procedure has failed. Therefore, a path configuration procedure between the mobile XDU and the adjacent XDU may not be performed. Also, if the initiation request message of the adjacent XDU is not received within the T380 regardless of whether the T370 is expired, the mobility support procedure of the mobile XDU may be controlled to be determined as failed. In this case, a start condition (or restart condition) of T380 may be defined as “when the mobile XDU starts the monitoring operation for the adjacent XDU”, “when the mobile XDU transmits a control message triggering the handover”, or the like. The timers previously described (e.g., T350, T360, T370, T380) may be transmitted to the mobile XDU via system information or a control message.

Meanwhile, if the configuration information of the linked XDU is received in the step S605, the mobile XDU may determine the target XDU based on the configuration information of the linked XDU without performing the step S609. For example, the mobile XDU may determine at least one XDU among the linked XDUs indicated by the configuration information of the linked XDU as the target XDU.

If the target XDU determined by the mobile XDU is an adjacent XDU, the mobile XDU may transmit to the adjacent XDU a path configuration request message including the configuration information of the serving XDU, the information on the communication service requested by the mobile XDU (or the information on the communication service provided to the mobile XDU). That is, a path configuration procedure between the mobile XDU and the adjacent XDU may be performed.

Meanwhile, the information necessary for determining the target XDU in the mobile XDU (hereinafter referred to as ‘target XDU determination information’) may be transmitted from the XDU (e.g., serving XDU, adjacent XDU) belonging to the Xhaul network. The target XDU determination information may include information indicating whether or not to permit a determination procedure of the target XDU performed by the mobile XDU (hereinafter referred to as ‘mobile XDU-based target XDU determination procedure’), load status information, reference values for channel quality measurement, capability information, and the like.

In the mobile XDU-based target XDU determination procedure, the mobile XDU may determine the target XDU. In case that the mobile XDU-based target XDU determination procedure is allowed, a fixed XDU (e.g., a serving XDU, a linked XDU, or an adjacent XDU) may transmit, to the mobile XDU, information indicating that the mobile XDU-based target XDU determination procedure is allowed via system information, a common control message, or a dedicated control message. Here, the fixed XDU may indicate an XDU that does not have mobility. Also, the mobile XDU may transmit, to the fixed XDU, information (e.g., capability information) indicating whether or not the mobile XDU-based target XDU determination procedure is supported through a control message. Thus, if the mobile XDU and the target XDU support the mobile XDU-based target XDU determination procedure, the fixed XDU may configure parameters for the mobile XDU-based target XDU determination procedure, and may transmit a control message including the configured parameters.

Among the target XDU determination information, load status information may indicate a load status from a viewpoint of the communication service provided by the corresponding XDU (or the system capacity of the corresponding XDU). For example, the load status information may include information on communication services currently available versus available communication services, information on current system usage versus available system capacity, information on additional communication services that may be provided, information on additional available system capacity, margin information, or the like. Among the target XDU determination information, the reference values for channel quality measurement may indicate a reference value of the channel quality of the serving XDU (or the target XDU). The mobile XDU may determine the target XDU using the reference value of channel quality measurement. When a beamforming scheme is used, the reference value of channel quality measurement may indicate a reference value of channel quality for each beam or each beam group. Among the target XDU determination information, the capability information may indicate mobile XDUs that can be additionally accommodated in addition to mobile XDUs for which the corresponding XDU is providing communication services.

The target XDU determination information may be transmitted in a broadcast scheme or a multicast scheme. In this case, the mobile XDU may obtain the target XDU determination information from the serving XDU or the target XDU. Alternatively, the target XDU determination information may be transmitted via a dedicated control message. In this case, the mobile XDU may obtain target XDU determination information from the serving XDU. Therefore, the mobile XDU may determine an optimal target XDU using the channel quality of the serving XDU (or the target XDU) measured by the mobile XDU and the target XDU determination information. The mobile XDU may request to perform a mobility support procedure (e.g., a handover procedure) by reporting configuration information of the determined target XDU to the serving XDU. Alternatively, the mobile XDU may request the determined target XDU to perform a mobility support procedure (e.g., a handover procedure). In this case, the mobile XDU may transmit, to the target XDU (i.e., adjacent XDU), a message requesting to perform the mobility support procedure in the step S610. That is, if the target XDU determination information indicates that the mobile XDU-based target XDU determination procedure is allowed, the mobile XDU may directly request the target XDU to perform the mobility support procedure.

When the target XDU is determined by the mobile XDU, the target XDU that has received the message requesting to perform the mobility support procedure may use the configuration information of the serving XDU and the connection configuration information obtained from the mobile XDU to determine validity of the mobile XDU and whether or not to accept the request of mobility support. The target XDU may transmit a result of the determination result to the mobile XDU in the step S611. The connection configuration information may include configuration information (e.g., radio resource control (RRC) context information, access stratum (AS) configuration information in the LTE-based communication system) for connection of an access link between the mobile XDU and the fixed XDU (e.g., serving XDU, linked XDU, adjacent XDU, target XDU).

On the other hand, in the step S603, if a control message (e.g., a control message instructing to perform the XDU change, a message instructing to execute the handover procedure) is not received within a predetermined time (e.g., a handover execution timer) from the transmission time of the measurement report message (or the message requesting the XDU change), the mobile XDU may determine the target XDU and perform a mobility support procedure (e.g., handover procedure) with the determined target XDU.

The handover execution timer may be used to trigger a handover procedure controlled by a communication node having mobility (e.g., mobile XDU). The handover procedure controlled by the mobile XDU may be referred to as ‘mobile handover procedure’. When the mobile XDU transmits a control message requesting to perform a mobility support procedure, the handover execution timer may be started. If a control message instructing to execute a mobility support procedure is received from a fixed XDU before expiration of the handover execution timer, the handover execution timer may be stopped or reset. If the control message instructing to execute a mobility support procedure is not received from a fixed XDU before expiration of the handover execution timer, the mobile XDU may determine the target XDU and request the determined target XDU to perform a mobility support procedure. In this case, the mobile XDU may determine the target XDU based on information indicating whether the mobile handover procedure is allowed, load status information, load status information, reference value of the channel quality measurement, and the like, which are obtained from the fixed XDU.

Beam Pairing Procedure for Mobility Support Procedure

In order to efficiently perform the mobility support procedure (e.g., handover procedure), the mobile XDU may perform a beam pairing procedure by performing a beam sweeping procedure or an access procedure with an XDU (e.g., candidate target XDU) whose channel quality satisfies a preset reference value. The beam pairing procedure may be performed before the mobile XDU transmits a message requesting to perform the mobility support procedure to the serving XDU, or before the target XDU is determined. The beam pairing procedure may be a procedure for determining optimal transmit/receive beams (e.g., a beam group) between the mobile XDU and the fixed XDU (e.g., adjacent XDU).

In a receive beam pairing procedure, the mobile XDU may select a beam having a channel quality equal to or greater than a predetermined threshold among beams received from the fixed XDU, and may transmit an index of the selected beam to the fixed XDU. The index of the beam selected by the mobile XDU may be transmitted to the fixed XDU via the serving XDU. Alternatively, the index of the beam selected by the mobile XDU may be transmitted to the fixed XDU through an access procedure between the mobile XDU and the fixed XDU.

For a transmit beam pairing procedure, the mobile XDU may transmit reference signals and the fixed XDU may identify an optimal receive beam corresponding to the transmit beam of the mobile XDU based on the reference signals received from the mobile XDU. Alternatively, an access procedure between the mobile XDU and the fixed XDU may be performed. In this case, the fixed XDU may identify the optimal receive beam corresponding to the transmit beam of the mobile XDU based on the signal received from the mobile XDU in the access procedure. When the access procedure between the mobile XDU and the fixed XDU is performed, the mobile XDU may transmit a preamble for the access procedure, an identifier of the mobile XDU, control information indicating that the access procedure is performed for a mobility support procedure, control information indicating that the access procedure is performed for the beam pairing procedure, or the like. In this case, a radio resource (e.g., time resource, frequency resource) through which the preamble is transmitted may be different from a radio resource through which other information (e.g., the identifier, the control information) is transmitted.

In the access procedure for the beam pairing procedure, the identifier of the mobile XDU may be, in the integrated communication system, an identifier that uniquely identifies the mobile XDU, an identifier that uniquely identifies the mobile XDU in a local area consisting of a plurality of fixed XDUs, or an identifier that uniquely identifies the mobile XDU in a service area of a fixed XDU. Information for beam pairing (e.g., identifier of the XDU, beam indexes, etc.) may be generated even when a connection establishment or a connection configuration between the mobile XDU and the fixed XDU is not performed in the beam pairing procedure.

Regardless of the connection establishment or connection configuration between the mobile XDU and the fixed XDU, each of the mobile XDU and the fixed XDU may use the identifier of the mobile XDU, the identifier of the fixed XDU, the index of the transmit beam, the index of the receive beam to generate, allocate, store, maintain, change, and manage information for beam pairing. The information for beam pairing may be configured and managed according to a reason for performing the access procedure of the mobile XDU. The access procedure of the mobile XDU may be performed for a handover procedure, a beam pairing procedure, an initial access procedure, a discontinuous reception (DRX) related procedure, and the like. Among the DRX related procedures, the mobile XDU may perform the beam pairing procedure with the fixed XDU for a DRX-related synchronization procedure, an on-duration procedure, a downlink reception procedure, an uplink transmission procedure, or the like. Each of the mobile XDU and fixed XDU may determine beam configuration (e.g., shape, pattern), beam index, etc. through the beam pairing procedure.

In case that the beam pairing procedure between the mobile XDU and the target XDU is performed prior to the initiation of the mobility support procedure, the mobile XDU may omit or minimize a beam sweeping procedure during the mobility support procedure, a procedure for repeatedly transmitting a preamble (e.g., control message) for the target XDU using a plurality of beams, a procedure for repeatedly receiving packets from the fixed XDU, and the like. The mobile XDU may perform the mobility support procedure by performing a procedure for transmitting a preamble for an access procedure to the target XDU, a transmission and reception procedure using a predetermined beam (e.g., a beam corresponding to the beam index) to receive a control message (or, scheduling information) from the target XDU, and the like. Here, the beam pairing procedure may be included in the beam sweeping procedure.

Mobile Handover Procedure

Meanwhile, in the mobile handover procedure, a handover failure (HOF) or a handover success may be determined according to whether a handover completion message is received through the access procedure with the target XDU within a predetermined time after the mobile XDU transmits a handover request message to the serving XDU. Therefore, a timer (hereinafter referred to as a ‘handover failure determination timer’) for determining the handover failure or the handover success may be configured. The handover failure determination timer may be started at the time of transmitting the handover request message at the mobile XDU and may be stopped when the handover completion message is received. If the handover completion message is not received before expiration of the handover failure determination timer, the mobile XDU may determine that the handover has failed and may perform a connection re-establishment procedure.

Alternatively, the start time of the handover failure determination timer may be configured as a start time of the mobile handover procedure. For example, if a message instructing to execute the handover is not received within a predetermined time from the transmission time of the handover request message at the mobile XDU, the mobile XDU may perform the mobile handover procedure, and the handover failure determination timer may be started at the start time of the mobile handover procedure. If the handover completion message is not received before expiration of the handover failure determination timer, the mobile XDU may determine that the handover has failed and may perform a connection re-establishment procedure. On the other hand, if the handover completion message is received before expiration of the handover failure determination timer, the mobile XDU may determine that the handover procedure has been successfully performed, and may stop the handover failure determination timer.

Meanwhile, for the mobile handover procedure, the fixed XDU (e.g., serving XDU, linked XDU) may transmit a reference value of channel quality for the target XDU to the mobile XDU. In this case, the mobile XDU may compare a measured channel quality of the XDU (e.g., received signal strength indicator (RSSI), reference signal received power (RSRP), or reference signal received quality (RSRQ)), and determine the XDU as the target XDU when the channel quality of the measured XDU is equal to or greater than the reference value of channel quality. The mobile XDU may transmit a control message requesting a handover to the determined target XDU.

The reference value of channel quality may be configured as a measured value of channel quality of the target XDU. Alternatively, the reference value of channel quality may be set to a difference between the measured value of channel quality of the target XDU and the measured value of channel quality of the serving XDU. In this case, the reference value of channel quality may be set to a value relative to the measured value of channel quality of the serving XDU (e.g., a value in dB). If the measured channel quality of the XDU satisfies the relative value to the measured channel quality of the serving XDU, the mobile XDU may determine the corresponding XDU as the target XDU. The reference value of channel quality may be configured according to the property of the target XDU (e.g., type of the network to which the target XDU belongs, RAT applied to the network to which the target XDU belongs, transmit power of the XDU, type of TRP, RRH, cell, and base station, or the like), and may be transmitted to the mobile XDU via system information or a dedicated control message.

Meanwhile, in the mobile handover procedure, the handover failure determination timer, the reference value of channel quality of the target XDU, load status information of the target XDU, and the like may be used. When the handover failure determination timer expires, the measured channel quality of the XDU satisfies the reference value of channel quality, or the load status information satisfies a preset reference, the mobile XDU may determine the target XDU. Accordingly, the mobile XDU may determine the target XDU, and perform an access procedure or a handover procedure with the determined target XDU.

Meanwhile, the mobile XDU may generate movement status information. The mobile XDU located in an autonomous driving vehicle or a vehicle under running based on a navigation function may move along a predetermined path from an origin to a destination based on environments of roads (e.g., vehicle flow on the roads, properties of the roads). In this case, the mobile XDU may move using location information according to GPS, built-in sensor, positioning algorithm, and the like. The properties of the road may include the type of the road (e.g., city road, arterial road, back road, motorway, highway, etc.), a width of a lane, the number of lanes, etc. The mobile XDU may report location information (e.g., origin, waypoint, destination, current location, etc.). The location information may be geographical location information, property information of the location, cell information of the communication system at the location, and the like. The geographic location information may be GPS-based information (e.g., latitude and longitude), altitude information, address, and the like. The property information of the corresponding location may indicate geographical characteristics such as building, road, open space, residential area, commercial district, bridge, coastal area, forest, river, and the like. Also, the property information of the corresponding location may indicate size, height, area, and the like of a structure existing at the corresponding location. The XDU information of the Xhaul network at that location may be an identifier of the XDU (e.g., physical layer identifier, unique identifier), geopolitical location information, and the like.

Packet Transmission and Reception Method of Mobile XDU

A path between the mobile XDU and at least one serving XDU may be configured, and a path between the mobile XDU and at least one linked XDU may be configured. For example, an XCU (e.g., a PM function block of the XCU) may configure an Xhaul link between the mobile XDU and at least one serving XDU and an Xhaul link between the mobile XDU and at least one linked XDU. Accordingly, the mobile XDU may be connected with a plurality of XDUs (e.g., serving XDUs, linked XDUs) through the Xhaul links, and may perform packet transmission and reception procedures with each of the plurality of linked XDUs.

The mobile XDU may receive a packet from the serving XDU by monitoring the Xhaul link established between the mobile XDU and the serving XDU, and may transmit a packet to the serving XDU based on the following methods.

1) Method 1: Packet Transmission and Reception Method Based on Transmission Resources Scheduled by Serving XDU
In the step of establishing the Xhaul link between the mobile XDU and the serving XDU, the serving XDU may allocate a control channel (or data channel) to the mobile XDU, and notify information of the allocated control channel (or data channel) to the mobile XDU. The mobile XDU may transmit a resource allocation request message to the serving XDU using the control channel (or data channel) allocated by the serving XDU. The resource allocation request message may include information indicating a state of a transmission buffer of the mobile XDU. The serving XDU receiving the resource allocation request message from the mobile XDU may allocate transmission resources to the mobile XDU in consideration of the property of the communication service, the property of the Xhaul link, the state of the transmission buffer of the mobile XDU, and the like, and notify information on the allocated transmission resources to the mobile XDU. The mobile XDU may transmit a packet to the serving XDU using the transmission resources allocated by the serving XDU, and the serving XDU may receive the packet from the mobile XDU over the transmission resources.

2) Method 2: Packet Transmission and Reception Method Based on Transmission Resources Randomly Selected by Mobile XDU
The mobile XDU may randomly select transmission resources, and transmit A packet to the serving XDU using the selected transmission resources. The serving XDU may receive the packet from the mobile XDU by continuously monitoring the Xhaul link between the serving XDU and the mobile XDU.
Alternatively, in the step (or a separate signaling step) of establishing the Xhaul link between the mobile XDU and the serving XDU, the serving XDU may configure a transmission resource pool (e.g., transmission interval) for the mobile XDU, and inform the mobile XDU of the configured transmission resource pool (e.g., transmission interval). The mobile XDU may randomly select transmission resources in the preconfigured transmission resource pool (e.g., a transmission interval), and transmit a packet to the serving XDU using the selected transmission resources. The serving XDU may receive the packet from the mobile XDU by performing a monitoring operation on the preconfigured transmission resource pool (e.g., transmission interval).

On the other hand, even if the path configuration between the mobile XDU and the linked XDU is completed, the control channel (or data channel) may not be configured between the mobile XDU and the linked XDU. Alternatively, the control channel (or data channel) between the mobile XDU and the linked XDU may be configured to be restrictly used. For example, the state of the Xhaul link between the mobile XDU and the linked XDU may be inactive. The inactive state of the Xhaul link may be a state in which the control channel (or data channel) is not configured in the Xhaul link, or a state in which the control channel (or data channel) is configured to be restrictly used (e.g., a state in which the control channel (or data channel) is invalid).

Therefore, for the packet transmission and reception procedure between the mobile XDU and the linked XDU, an activation procedure of the Xhaul link (e.g., control channel or data channel) between the mobile XDU and the linked XDU may be performed. For example, an activation request message requesting activation of the Xhaul link may be transmitted to the linked XDU, and based on the activation request message, the Xhaul link between the mobile XDU and the linked XDU may be activated so that the packet transmission and reception procedure may be performed using the activated Xhaul link. The activation request message may be transmitted by the mobile XDU, the serving XDU, or the XCU. The state change of the Xhaul link from the inactive state to the active state may mean that the linked XDU has been changed to the serving XDU. The activation procedure of the Xhaul link may be triggered by the mobile XDU, the serving XDU, the linked XDU, the XCU, or the like.

A packet transmission and reception procedure between the mobile XDU and the linked XDU may be performed based on the following methods even when the state of the Xhaul link between the mobile XDU and the linked XDU is in the inactive state.

1) Method 1: A Packet Transmission and Reception Method Based on Non-Contention-Based Resource Request Procedure
The linked XDU may allocate a channel (e.g., control channel) for transmitting and receiving a resource allocation request message, and may inform the mobile XDU of the allocated channel. A non-contention-based resource request procedure may be performed through the channel allocated by the linked XDU. The mobile XDU may transmit a resource allocation request message to the linked XDU over the channel allocated by the linked XDU. The linked XDU receiving the resource allocation request message from the mobile XDU may allocate transmission resources of the mobile XDU and may inform the mobile XDU of the allocated transmission resources. The mobile XDU may transmit a packet to the linked XDU using the transmission resources allocated by the linked XDU, and the linked XDU may receive the packet from the mobile XDU through the corresponding transmission resources.

2) Method 2: A Packet Transmission and Reception Method Based Contention-Based Resource Request Procedure
The linked XDU may transmit a discovery signal (or, common control signal) including information on a channel (e.g., control channel) for transmitting and receiving a resource allocation request message. A contention-based resource request procedure may be performed through the channel indicated by the discovery signal (or, common control signal). The mobile XDU may receive the discovery signal (or, common control signal) from the linked XDU and may transmit a resource allocation request message to the linked XDU through the channel indicated by the received discovery signal (or common control signal). When the resource allocation request message is received from the mobile XDU, the linked XDU may allocate transmission resources of the mobile XDU and inform the mobile XDU of the allocated transmission resources. The mobile XDU may transmit a packet to the linked XDU using the transmission resources allocated by the linked XDU, and the linked XDU may receive the packet from the mobile XDU through the corresponding transmission resources.

3) Method 3: A Packet Transmission and Reception Method Based Preconfigured Resources
It may be allowed for the mobile XDU to receive a packet from the linked XDU. In this case, the linked XDU may inform the mobile XDU of information on resources (e.g., transmission period, transmission interval, transmission resource, etc.) used for transmission of the packet, and transmit the packet through the resources indicated by the information on resources. The mobile XDU may receive a packet from the linked XDU by periodically (or continuously) monitoring the resources indicated by the resource information received from the linked XDU.

Redundant Transmission Method of Packets in Xhaul Network

Next, methods for redundant transmission of packets in the Xhaul network will be described.

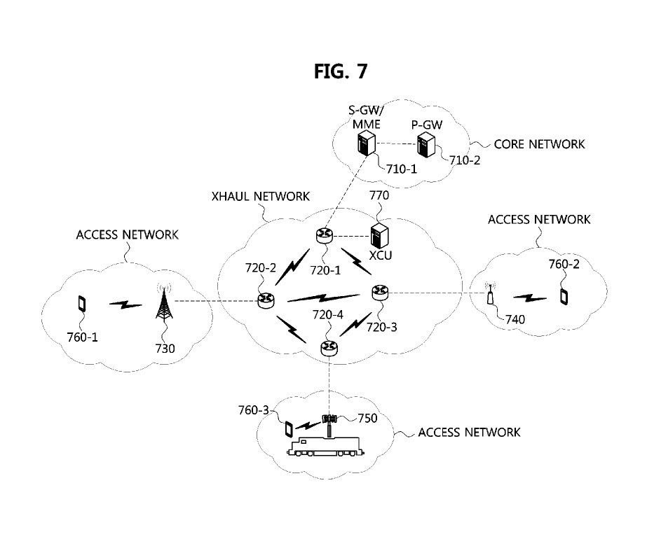

FIG. 7 is a conceptual diagram illustrating a third embodiment of an integrated communication system.

Referring to FIG. 7, the integrated communications system may include an access network, an Xhaul network, and a core network. The Xhaul network may be located between the access network and the core network, and may support communications between the access network and the core network. The communication nodes belonging to the integrated communication system may be configured to be the same as or similar to the communication node 200 shown in FIG. 2. The access network may include a macro base station 730, a small base station 740, a TRP 750, terminals 760-1, 760-2, and 760-3, and the like. The Xhaul network may include a plurality of communication nodes 720-1, 720-2, 720-3, and 720-4. The communication node constituting the Xhaul network may be referred to as an ‘XDU’. In the Xhaul network, the XDUs 720-1, 720-2, 720-3, and 720-4 may be connected using wireless Xhaul links and may be connected based on a multi-hop scheme. An XCU 770 may belong to the Xhaul network, and may be connected to the first XDU 720-1. The core network may include an S-GW/MME 710-1, a P-GW 710-2, and the like. The S-GW/MME 710-1 may refer to a communication node including an S-GW and an MME.

The first XDU 720-1 of the Xhaul network may be connected to the S-GW/MME 710-1 through a wired link, or may be an XDU aggregator. Thus, the first XDU 720-1 may be referred to as an XDU aggregator. The first XDU 720-1 may be connected to the XCU 770. The second XDU 720-2 may be connected to the macro base station 730 through a wired link. The macro base station 730 may provide communication services to the first terminal 760-1 using an access protocol (e.g., 4G communication protocol, 5G communication protocol). The third XDU 720-3 may be connected to the small base station 740 through a wired link. The small base station 740 may provide communication services to the second terminal 760-2 using an access protocol (e.g., 4G communication protocol, 5G communication protocol).

The fourth XDU 720-4 may be connected to the TRP 750 through a wired link. Alternatively, the fourth XDU 720-4 may be configured as integrated into the TRP 750. The TRP 750 may provide communication services to the third terminal 760-3 using an access protocol (e.g., 4G communication protocol, 5G communication protocol). The fourth XDU 720-4, the TRP 750, and the third terminal 760-3 may be located in a train. Since the fourth XDU 720-4 is located in the train having mobility, the fourth XDU 720-4 may be a ‘mobile XDU’. Also, the second XDU 720-2 may be a ‘serving XDU’ for the fourth XDU 720-4, and the third XDU 720-3 may be a ‘linked XDU’ for the fourth XDU 720-4. Thus, the second XDU 720-2 may be referred to as ‘serving XDU 720-2’, the third XDU 720-3 may be referred to as ‘linked XDU 720-3’, and the fourth XDU 720-4 may be referred to as ‘mobile XDU 720-4’.

In order to improve reliability of packet transmission and reception procedures between the mobile XDU 720-4 and the XDU aggregator 720-1 in the Xhaul network, the XCU 770 (e.g. a MM function block of the XCU 770) may support a bi-casting function (e.g., a redundant transmission function), a packet forwarding function, or the like. The bi-casting function and the packet forwarding function may be used not only for the packet transmission procedure from the XDU aggregator 720-1 to the mobile XDU 720-4, but also for the packet transmission procedure from the mobile XDU 720-4 to the XDU aggregator 720-1.

The bi-casting function may be performed at a time point when a path between the mobile XDU 720-4 and the serving XDU 720-2 is configured. When the bi-casting function is applied in the packet transmission and reception procedure between the mobile XDU 720-4 and the XDU aggregator 720-1, the XCU 770 may configure a bi-casting path. The bi-casting path may include a path of ‘XDU aggregator 720-1-serving XDU 720-2’ and a path of ‘XDU aggregator 720-1-linked XDU 720-3’. The XCU 770 may notify, to the XDU aggregator 720, information on the bi-casting path, configuration information of the XDUs located in the bi-casting path (e.g., configuration information of the serving XDU 720-2 and configuration information of the linked XDU 720-3), and the like.

The XDU aggregator 720-1 may receive the information related to the bi-casting function (e.g., the information on the bi-casting path information, the configuration information of XDUs located in the bi-casting path, etc.) from the XCU 770, and perform the bi-casting function based on the received information. For example, when the XDU aggregator 720-1 receives a packet to be transmitted from the core network to the mobile XDU 720-4, the XDU aggregator 720-1 may transmits the packet to the serving XDU 720-2 and the linked XDU 720-3. That is, the same packet may be transmitted to the serving XDU 720-2 and the linked XDU 720-3.

The serving XDU 720-2 may receive the packet from the XDU aggregator 720-1, and may transmit the received packet to the mobile XDU 720-4. The linked XDU 720-3 may receive the packet from the XDU aggregator 720-1 and may transmit the received packet to the mobile XDU 720-4. Alternatively, the linked XDU 720-3 may discard the packet received from the XDU aggregator 720-1. Thus, the mobile XDU 720-4 may receive the packet from at least one of the serving XDU 720-2 and the linked XDU 720-3.

On the other hand, if the mobile XDU 720-4 fails to receive the packet from the serving XDU 720-2 within a predetermined time from the execution time of the bi-casting function, the serving XDU 720-2 may forward the packet to be transmitted to the mobile XDU 720-4 to the linked XDU 720-3. For example, if the state of the Xhaul link between the serving XDU 720-2 and the mobile XDU 720-4 is bad, the mobile XDU 720-4 may not receive the packet from the serving XDU 720-2. In this case, the packet may be transmitted to the mobile XDU 720-4 via a path of ‘linked XDU 720-3-mobile XDU 720-4’. The packet forwarding function may be controlled by the XCU 770.

For the packet forwarding function, the XCU 770 (or, the XDU aggregator 720-1) may transmit a control message including the execution time of the bi-casting function, a timer for the packet forwarding function, etc. to the serving XDU 720-2. The serving XDU 720-2 may identify the execution time of the bi-casting function, the timer for the packet forwarding function, and the like based on the control message received from the XCU 770 (or the XDU aggregator 720-1). The serving XDU 720-2 may start the timer for the packet forwarding function at the time of performing the bi-casting function. If the mobile XDU 720-4 fails to receive a packet from the serving XDU 720-2 for a time corresponding to the timer for the packet forwarding function, the serving XDU 720-2 may determine that the bi-casting function is not normally performed, and forward the packet to be transmitted to the mobile XDU 720-4 to the linked XDU 720-3.

Meanwhile, when the third XDU 720-3 is a serving XDU, the third XDU 720-3 may transmit the packet received from the XDU aggregator 720-1 to the mobile XDU 720-4. On the other hand, if the third XDU 720-3 is a linked XDU, the third XDU 720-3 may discard packets received from the XDU aggregator 720-1 before being changed from the linked XDU to the serving XDU. In other words, the third XDU 720-3 may transmit, to the mobile XDU 720-4, the packet received from the XDU aggregator 720-1 after being changed from the linked XDU to the serving XDU.

Alternatively, a bi-casting function for the mobile XDU 720-4 may be performed when both the second XDU 720-2 and the third XDU 720-3 in the Xhaul network are serving XDUs. Therefore, if the third XDU 720-3 is a linked XDU, the bi-casting function may not be performed, and if the third XDU 720-3 is changed to a serving XDU by a mobility support procedure, the bi-casting function may be performed.

If the mobility support procedure causes a change in the operational state between the linked XDU and the serving XDU, the reliability of the packet transmission may not be ensured. For example, before the packet is transmitted from the second XDU 720-2 to the mobile XDU 720-4, the operational state of the second XDU 720-2 may be changed from the serving XDU to the linked XDU, and the operational state of the third XDU 720-3 may be changed from the linked XDU to the serving XDU before the packet is transmitted from the XDU aggregator 720-1 to the third XDU 720-3. In this case, since the packet to be transmitted to the mobile XDU 720-4 exists in the second XDU 720-2 and the second XDU 720-2 operating as a linked XDU cannot transmit the packet to the mobile XDU 720-4, the mobile XDU 720-4 may not receive the packet. In order to solve this problem, the second XDU 720-2 operating as a linked XDU may be controlled to forward the packet to the third XDU 720-3 operating as a serving XDU.

When the XDU aggregator 720-1 transmits the same packet to the second XDU 720-2 and the third XDU 720-3 before performing the procedure of changing the operation state of the XDU, the packet may be transmitted to the mobile XDU 720-4 without a packet forwarding procedure between the second XDU 720-2 and the third XDU 720-3. The bi-casting function may be performed before the procedure of changing the operational state of the XDU is performed in consideration of the load status information of the Xhaul network, channel information between the XDUs, the location information of the mobile XDU (or the serving XDU or linked XDU), and the like.

Meanwhile, when the bi-casting function is performed by the serving XDU and the linked XDU in the X-hall network, a mobile handover procedure may be performed. That is, the mobile XDU 720-4 may request the linked XDU to perform the handover procedure, and when the state of the Xhaul link between the linked XDU and the mobile XDU 720-4 is changed from the inactive state to the active state, the handover procedure may be completed.

Mobility Support Procedure Based on a Distance Between XDUs

On the other hand, the mobile XDU located in a vehicle (or, train or aircraft) moving along a preconfigured path may perform a mobility support function by using the location information of the mobile XDU, the location information of the serving XDU, the location information of the linked XDU, the location information of the target XDU, and the like. The target XDU may be configured based on a distance between the mobile XDU and another XDU (e.g., a serving XDU, a linked XDU, a target XDU, and the like), channel quality information of the Xhaul link, and the like, without a triggering procedure for the mobility support function (or, a procedure for changing the operational state of the XDU). Also, the target XDU may be changed to a linked XDU or a serving XDU, the linked XDU may be changed to a serving XDU, and the serving XDU may be changed to a linked XDU.

A path between the XDU located in the movement path of the mobile XDU and the mobile XDU may be configured, and a path between an XDU located within a predetermined distance from the mobile XDU (e.g., another XDU belonging to a local area to which the mobile XDU belongs) and the mobile XDU may be configured. The XDU for which the path is configured with the mobile XDU may be configured as a linked XDU or a target XDU. If a distance between the mobile XDU and the linked XDU (or target XDU) is less than a predetermined threshold, the linked XDU (or target XDU) may be changed to a serving XDU. Alternatively, the Xhaul link between the mobile XDU and the linked XDU (or the target XDU) may be activated so that the linked XDU (or the target XDU) may operate as a serving XDU.

When the distance between the mobile XDU and the serving XDU is greater than or equal to a preset threshold, the serving XDU may be changed to a linked XDU. Alternatively, the serving XDU may operate as a linked XDU by deactivating the Xhaul link between the mobile XDU and the serving XDU. The channel quality information of the Xhaul link may be considered in the mobility support procedure based on the distance between the mobile XDU and another XDU.

Meanwhile, when a plurality of paths are configured between the mobile XDU and a plurality of XDUs and the mobility support procedure (e.g., handover procedure) of the mobile XDU is performed, the mobile XDU may transmit a handover completion message to one of the plurality of XDUs. The XDU that has received the handover completion message from the mobile XDU may inform the remaining XDUs of the plurality of XDUs that the handover completion message has been received.

Access Method in Integrated Communication System

Next, access methods in the integrated communication system will be described.

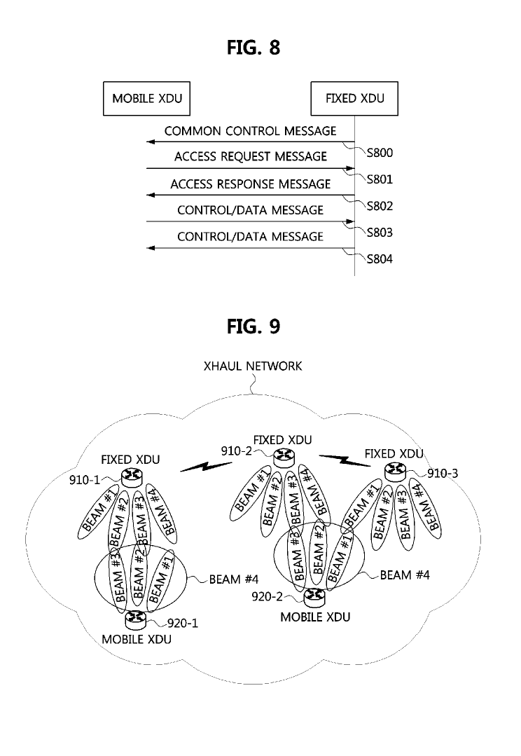

FIG. 8 is a sequence chart illustrating a first embodiment of an access method in the integrated communication system.

Referring to FIG. 8, an access procedure may be classified into an access procedure #1 and an access procedure #2. In the access procedure #1, steps S800 to S804 may be performed, and the access procedure #1 between a mobile XDU and a fixed XDU may be completed after the end of step S804. In the access procedure #2, the steps S800 to S802 may be performed, and the access procedure #2 between a mobile XDU and a fixed XDU may be completed after the end of step S802. In the below description, operations not specified to be performed in the access procedure #1 or the access procedure #2 may be commonly performed in the access procedure #1 and the access procedure #2.

The mobile XDU may be an XDU located in a mobile device having mobility among XDUs belonging to an Xhaul network (e.g., the Xhaul network shown in FIG. 4, FIG. 5, or FIG. 7). Alternatively, the mobile XDU may be a terminal belonging to an access network (e.g., the access network shown in FIG. 4, FIG. 5, or FIG. 7). That is, the operations performed by the mobile XDU in the below description may also be performed by the terminal. The fixed XDU may be an XDU fixed at a specific position among the XDUs belonging to the Xhaul network (e.g., the Xhaul network shown in FIG. 4, FIG. 5, or FIG. 7). Alternatively, the fixed XDU may be a base station (e.g., a macro base station, a small base station, a TRP, etc.) belonging to the access network (e.g., the access network shown in FIG. 4, FIG. 5, or FIG. 7). That is, the operation performed by the fixed XDU in the below description may also be performed by the base station.

The fixed XDU may generate a common control message including common control information. The common control information may indicate a resource allocated for transmission of an access request message of the step S801. The common control information may be generated by the fixed XDU or may be obtained from another fixed XDU belonging to the communication system. For example, when transmission and reception procedures of the access request message are performed by a plurality of XDUs using the same resource, the fixed XDU may obtain information on the resource through which the access request message is transmitted from another fixed XDU. The fixed XDU may transmit the common control message (S800).

The mobile XDU may receive the common control message from the fixed XDU or another fixed XDU and may identify the common control information included in the received common control message. The mobile XDU may generate an access request message and may transmit the access request message to the fixed XDU through the resource indicated by the common control information (S801). The access request message may include a preamble (e.g., signature) configured for the mobile XDU. The preamble may be configured based on a specific sequence. For example, in the access procedure #1, the access request message may include the preamble, and in the access procedure #2, the access request message may not include the preamble.

Also, the access request message may further include an identifier of the mobile XDU. When the access request message is transmitted based on a contention-based transmission procedure, the access request message may include the identifier of the mobile XDU. On the other hand, if the access request message is transmitted based on a non-contention-based transmission procedure, the access request message may not include the identifier of the mobile XDU.

When the access request message is received from the mobile XDU, the fixed XDU may generate an access response message in response to the access request message. The access response message may include information on a resource allocated for transmission of a control message (or data message) of the step S803. The resource indicated by the access response message may be a resource configured for the contention-based transmission procedure or the non-contention-based transmission procedure. The fixed XDU may transmit the access response message (S802).

In case that the resource indicated by the access response message is a resource configured for the contention-based transmission procedure, the access response message may include type information of the mobile XDU, type information of the communication service, a classifier or discriminator indicating a group to which the mobile XDU belongs, and the like. The classifier may be configured to be mapped to the resource indicated by the access response message. On the other hand, if the resource indicated by the access response message is a resource configured for the non-contention-based transmission procedures, the access response message may include a preamble (e.g., signature) of the mobile XDU obtained from the access request message, an identifier capable of distinguishing the mobile XDU in the integrated communication system (e.g., the access network, the Xhaul network, and the like).

The mobile XDU may receive the access response message from the fixed XDU and may verify the information included in the access response message. The mobile XDU may transmit a control message (or, data message) to the fixed XDU through the resource indicated by the access response message or a preconfigured resource (e.g., a resource configured for the contention-based transmission procedure) (S803). The fixed XDU may receive the control message (or, data message) from the mobile XDU. Here, the control message (or data message) of the mobile XDU may include the identifier, property information, capability information, etc. of the mobile XDU.

Meanwhile, the fixed XDU may transmit the control message (or, data message) in a unicast scheme, a broadcast scheme, or a multicast scheme (S804). In case that the unicast scheme is used for the transmission of the control message (or, data message), the fixed XDU may transmit the control message (or, data message) using a predetermined resource for the mobile XDU. In case that the broadcast scheme is used for the transmission of the control message (or, data message), the fixed XDU may transmit the control message (or, data message) using a common resource configured for all XDUs in a service coverage of the fixed XDU. In case that the multicast scheme is used for the transmission of the control message (or, data message), the fixed XDU may transmit the control message (or, data message) using a specific resource configured for XDUs belonging to a specific group. In the step S804, the transmission scheme of the control message (or, data message) may be determined based on the transmission scheme (e.g., the contention-based transmission procedure, the non-contention-based transmission procedure) of the access request message in the step S801, information related to the control message (or, data message) of the step S803, and the like.

Meanwhile, in case that the access request message is transmitted according to the contention-based transmission procedure in the step S801 of the access procedure #2, the fixed XDU may transmit the access response message including the identifier of the mobile XDU in the step S802. In this case, the mobile XDU may determine that the access request message has been successfully received in the fixed XDU when the identifier included in the access response message received from the fixed XDU is equal to the identifier of the mobile XDU. On the other hand, if the identifier included in the access response message received from the fixed XDU is not the identifier of the mobile XDU, the mobile XDU may determine that the access request message has not been received in the fixed XDU, and retransmit the access request message to the fixed XDU. In case that the access request message is transmitted according to the non-contention-based transmission procedure in the step S801 of the access procedure #2, the access response message transmitted from the fixed XDU in the step S802 may not include the identifier of the mobile XDU.

When the access procedure #2 is completed, the mobile XDU may operate in a connected state, and the mobile XDU operating in the connected state may perform a DRX operation. The fixed XDU may also provide communication services to the mobile XDU. When the transmission and reception procedure of the control message (or, data message) between the mobile XDU and the fixed XDU is completed in the access procedure #2, the mobile XDU may release the connection with the fixed XDU and operate in an idle state. In the access procedure #2, if the transmission and reception procedure of the control message (or, data message) between the mobile XDU and the fixed XDU is completed without establishing a connection between the mobile XDU and the fixed XDU, the mobile XDU may operate in the idle state, and the mobile XDU operating in the idle state may perform a DRX operation.

Meanwhile, in the access procedure, the mobile XDU may request the fixed XDU to transmit necessary information (e.g., system information, common control information, etc.). For example, in the step S801, the mobile XDU may transmit an access request message requesting transmission of the necessary information to the fixed XDU. The fixed XDU that has received the access request message may confirm that the necessary information is requested to be transmitted, generate an access response message containing the necessary information, and transmit the generated access response message in a unicast, broadcast or multicast scheme. The transmission scheme of the access response message may be determined based on the information included in the access request message (e.g., the identifier, property information, capability information of the mobile XDU, the preamble, the signature, the message type, etc.). Also, in the step S804, the transmission scheme of the control message (or, data message) may be the same as the transmission scheme of the access response message. For example, if the access response message is transmitted in the multicast scheme, the control message (or, data message) in the step S804 may be transmitted in the multicast scheme.

On the other hand, the access procedure may be performed without a feedback procedure for the message (e.g., an ACK/NACK transmission procedure according to a hybrid automatic repeat request (HARQ) operation). For example, the message may be repeatedly transmitted in the access procedure. In this case, resources for repeated transmission of the message may be allocated, and scheduling information (e.g., position of the resources, transmission period, transmission power, MCS, etc.) for the allocated resource may be configured.

Meanwhile, the access procedure may be classified into an initial access procedure and a non-initial access procedure. The initial access procedure may be performed without context information of the mobile XDU. The non-initial access procedure may be performed subsequently to the initial access procedure, and may be performed for a specific purpose. For example, the non-initial access procedure may be performed for a presence of a packet to be transmitted and received, a connection resumption, a resource allocation request, a request for information transmission, a link reset request after a radio link failure, a mobility support procedure (e.g., handover procedure), addition or change of a secondary cell, addition or change of an active beam, configuration of synchronization of the physical layer, and the like. The active beam may indicate a beam used for transmission and reception of a control message (or, data message) when a beamforming scheme is used.

The initial access procedure may vary depending on the resources allocated. For example, if the fixed XDU configures multi-beams based on the beam-forming scheme, and the resources for the initial access procedure are configured on a beam-by-beam basis, the steps S800 through S802 may be performed in the initial access procedure. That is, the steps S803 and S804 may not be performed in the initial access procedure. In this case, in the step S801, the mobile XDU may transmit an access request message using a preconfigured resource for beamforming. Here, the access request message may include a preamble, a signature, the identifier of the mobile XDU, a reason for performing the initial access procedure, and the like.

In the non-initial access procedure, the mobile XDU may select a preamble (e.g., signature) based on the reason for performing the non-initial access procedure, information to be transmitted and received, etc., and transmit an access request message including the selected preamble. The fixed XDU may receive the access request message from the mobile XDU, and confirm the reason for performing the non-initial access procedure, the information to be transmitted to the mobile XDU, and the like based on the preamble included in the received access request message. The fixed XDU may generate an access response message containing the information indicated by the access request message and may transmit the generated access response message. If the information requested by the mobile XDU is transmitted via the access response message, the non-initial access procedure may be terminated at the step S802.

In the non-initial access procedure, the mobile XDU may select a preamble (e.g., signature) based on the reason for performing the non-initial access procedure, the information to be transmitted and received, and transmit an access request message including the selected preamble. The fixed XDU may receive the access request message from the mobile XDU, and can confirm the reason for performing the non-initial access procedure, the information to be transmitted to the mobile XDU, and the like based on the preamble included in the received access request message. The fixed XDU may generate an access response message including the information indicated by the access request message and may transmit the generated access response message. When the information requested by the mobile XDU is transmitted via the access response message, the non-initial access procedure may be terminated at the step S802.

Operation Method of XDU Supporting Beam Forming in Xhaul Network

Next, operation methods of an XDU supporting a beam forming function in the Xhaul network will be described.

FIG. 9 is a conceptual diagram illustrating a first embodiment of an Xhaul network.

Referring to FIG. 9, the Xhaul network may belong to the integrated communication system, and may support communications between an access network and a core network. The Xhaul network may include a plurality of XDUs 910-1, 910-2, 910-3, 920-1, and 920-2, and the plurality of XDUs 910-1, 910-2, 910-3, 920-1, and 920-2 may be connected through Xhaul links. The plurality of XDUs 910-1, 910-2, 910-3, 920-1, and 920-2 may support beamforming functions. The fixed XDUs 910-1, 910-2, and 910-3 may be fixed in specific locations, and the mobile XDUs 920-1 and 920-2 may be located at mobile devices (e.g., automobiles, trains, aircraft, etc.). Each of the fixed XDUs 910-1, 910-2 and 910-3 may be a base station (e.g., macro base station, small base station, TRP) in the access network, and each of the mobile XDUs 920-1 and 920-2 may be a terminal in the access network.

A path may be configured between the first mobile XDU 920-1 and the first fixed XDU 910-1, and in this case, the first fixed XDU 910-1 may operate as a serving XDU of the first mobile XDU 920-1. Alternatively, the first mobile XDU 920-1 may be located within a service coverage of the first fixed XDU 910-1 without establishing a path with the first fixed XDU 910-1. A path may be configured between the second mobile XDU 920-2 and the second fixed XDU 910-2, and in this case, the second fixed XDU 910-2 may operate as a serving XDU of the second mobile XDU 920-2. Alternatively, the second mobile XDU 920-2 may be located within a service coverage of the second fixed XDU 910-2 without establishing a path with the second fixed XDU 910-2. The third fixed XDU 910-3 may operate as a linked XDU, a candidate linked XDU, a target XDU, a candidate target XDU, etc. for the second mobile XDU 920-2.

The mobile XDUs 920-1 and 920-2 may transmit discovery signals, reference signals, and the like. The mobile XDUs 920-1 and 920-2 having the paths to the serving XDUs may transmit discovery signals, reference signals, and the like through resources allocated by the serving XDUs. For example, the second mobile XDU 920-2 may transmit discovery signals, reference signals, and the like through resources allocated by the second fixed XDU 910-2. The second fixed XDU 910-2 may receive the discovery signals, the reference signals, and the like from the second mobile XDU 920-2, and may measure receive a radio channel quality (e.g., received signal strength, latency, BLER) between the second fixed XDU 910-2 and the second mobile XDU 920-2 based on the received signals.

The second fixed XDU 910-2 may provide the other fixed XDUs 910-1 and 910-3 with information on the resources through which the discovery signals, reference signals, etc. of the second mobile XDU 920-2 are transmitted. The information on the resources shared between the fixed XDUs 910-1, 910-2, and 910-3 may include positions of radio resources, transmission period, sequence allocation information for a scrambling operation or a masking operation, and the like. Also, the second fixed XDU 910-2 may inform the other fixed XDUs 910-1 and 910-3 of a movement direction of the second mobile XDU 920-2, measurement results (e.g., indexes of transmission beams satisfying a preconfigured criterion) on transmission beams of adjacent XDUs (e.g., the third fixed XDU 910-3) obtained from the second mobile XDU 920-2, and the like.

Accordingly, the third fixed XDU 910-3 adjacent to the second mobile XDU 920-2 may receive the discovery signals, the reference signals, etc. from the second mobile XDU 920-2 based on the information obtained from the second fixed XDU 910-2, and may measure a radio channel quality between the third fixed XDU 910-3 and the second mobile XDU 920-2 based on the received signals. In this case, the third fixed XDU 910-3 may measure the radio channel quality between the third fixed XDU 910-3 and the second mobile XDU 920-2 using all beams (e.g., beam #1 to beam #4). Alternatively, the third fixed XDU 910-3 may select a beam (e.g., beam #1) satisfying the preconfigured criterion among all the beams based on the information (e.g., the measurement results for the transmission beams) obtained from the second fixed XDU 910-2, and may use the selected beam to measure the radio channel quality between the third fixed XDU 910-3 and the second mobile XDU 920-2. Alternatively, when the index of the beam used for the measurement procedure is obtained from the second fixed XDU 910-2, the third fixed XDU 910-3 may use the beam indicated by the index to measure the radio channel quality between the second mobile XDU 910-3 and the second mobile XDU 920-2.

When the strength of the signal received from the second mobile XDU 920-2 in the measurement procedure of the radio channel quality is equal to or greater than a predetermined threshold, the third fixed XDU 910-3 may change an operational state of the third fixed XDU 910-3 to a serving XDU by performing a mobility support procedure (e.g., handover procedure) with the second fixed XDU 910-2. Alternatively, when the measurement result of the radio channel quality satisfies the selection criteria of linked XDU, the operational state of the third fixed XDU 910-3 may be changed to a linked XDU. Here, each of the predetermined threshold and the selection criteria of linked XDU may be configured differently according to the type of the signal.

Meanwhile, for the mobility support procedure (e.g., handover procedure) based on the discovery signals or reference signals of the mobile XDUs 920-1 and 920-2, the discovery signals and reference signals may be transmitted using a wide beam. For example, the mobile XDUs 920-1 and 920-2 may transmit the discovery signal, the reference signal, and the like using the beam #4.

Meanwhile, the first fixed XDU 910-1 may select an optimal beam using the discovery signals or the reference signals received from the first mobile XDU 920-1. For example, the first mobile XDU 920-1 may transmit discovery signals, reference signals, etc. by using the respective beams, and the first fixed XDU 910-1 may measure qualities of the discovery signals (or, reference signals) of the first mobile XDU 920-1 received through the respective beams.

Alternatively, the first fixed XDU 910-1 may use a part of all the beams (e.g., a beam adjacent to the beam providing communication services to the first mobile XDU 920-1) to perform a measurement procedure on the discovery signals (or, reference signals) of the first mobile XDU 920-1. For example, when the first fixed XDU 910-1 provides communication services to the first mobile XDU 910-1 using the beam #3, the first fixed XDU 910-1 may use the beams #2 and #4 adjacent to the beam #3 to perform the measurement procedure on the discovery signals (or, reference signals) of the first mobile XDU 920-1. In the measurement procedure on the discovery signals (or reference signals) of the first mobile XDU 920-1, the first fixed XDU 910-1 may compare qualities of the discovery signals (or reference signals) with a predetermined threshold, determine a beam through which a discovery signal (or, reference signal) satisfying the predetermined criterion is received as an optimal beam, and use the determined optimal beam to provide communication services to the first mobile XDU 920-1.

Meanwhile, the fixed XDUs 910-1, 910-2, and 910-3 may provide communication services to the mobile XDUs 920-1 and 920-2 using a plurality of beams. For example, the first fixed XDU 910-1 may allocate the beams #2 and #3 for communications with the first mobile XDU 920-1, and provide communication services to the first mobile XDU 920-1 using the beams #2 and #3. The second fixed XDU 910-2 may allocate the beams #3 and #4 for communications with the second mobile XDU 920-2, and provide communication services to the second mobile XDU 920-2 using the beams #3 and #4. The beams used for the communications between the fixed XDUs 910-1, 910-2, and 910-3 and the mobile XDUs 920-1 and 920-2 may be allocated based on a beam sweeping procedure. The beams used for the communications between the XDUs may be allocated by considering movement speeds, movement directions and locations of the mobile XDUs 920-1 and 920-2, radio channel qualities between the mobile XDUs 920-1 and 920-2 and the fixed XDUs 910-1, 910-2 and 910-3, beam interferences at the mobile XDUs 920-1 and 920-2, or the like.

For example, when the movement speed of the first mobile XDU 920-1 is relatively low, the first fixed XDU 910-1 may allocate contiguous beams (e.g., beam #2 and beam #3) for the communications with the first mobile XDU 920-1. On the other hand, when the movement speed of the first mobile XDU 920-1 is relatively high, the first fixed XDU 910-1 may allocate non-contiguous beams (e.g., beam #2 and beam #4) for the communications with the first mobile XDU 920-1.

Meanwhile, the second fixed XDU 910-2 may provide communication services to the second mobile XDU 920-2 using the beam #3 and beam #4. Here, when the second mobile XDU 920-2 moves from the service coverage of the second fixed XDU 910-2 to the service coverage of the third fixed XDU 910-3, a handover procedure between the second fixed XDU 910-2 and the third fixed XDU 910-3 may be performed. During the execution of the handover procedure, the second mobile XDU 920-2 may obtain configuration information of the beams of the third fixed XDU 910-3 from the second fixed XDU 910-2. The configuration information of the beams may include beam indexes (e.g., indexes of transmission beams, indexes of reception beams), transmission powers, widths, vertical angles, horizontal angles, transmission and reception timings (e.g., indexes (or, offsets) of subframe, slot, minislot, symbol, etc.), information on reference signals (e.g., a sequence or index of the reference signals), and the like configured by a beam sweeping procedure. That is, in the handover procedure between the second fixed XDU 910-2 and the third fixed XDU 910-3, information required for the beam allocation (e.g., the movement speed, movement direction and position of the second mobile XDU 920-2, and information related to the beam sweeping procedure) may be transmitted and received.

Meanwhile, when the second fixed XDU 910-2 and the third fixed XDU 910-3 belong to the same sector (or cell) and the second mobile XDU 920-2 moves from the service coverage of the second fixed XDU 910-2 to the service coverage of the third fixed XDU 910-3, the handover procedure may be performed in the sector. Here, each of the second fixed XDU 910-2 and the third fixed XDU 910-3 may include at least one of a physical layer, a medium access control (MAC) layer, a radio link control (RLC) layer, a packet data convergence protocol (PDCP) layer, an adaptation layer, and an RRC layer. The adaptation layer may be a layer higher than the PDCP layer, and may perform a mapping operation between a QoS flow and a radio bearer (e.g., data radio bearer (DRB)), a marking operation of an identifier of a QoS flow on a packet, and the like.

When the second fixed XDU 910-2 and the third fixed XDU 910-3 belonging to the same sector do not include the RRC layer, the handover procedure between the second fixed XDU 910-2 and the third fixed XDU 910-3 may be performed based on MAC layer control messages (e.g., MAC control element (CE), control protocol data unit (PDU), etc.) without RRC layer control messages. That is, the layer for generating the control messages for the handover procedure may be determined based on a hierarchical structure of the XDU performing the handover procedure.

When the second fixed XDU 910-2 and the third fixed XDU 910-3 include the physical layer and the MAC layer (or, physical layer, MAC layer, and RLC layer), the control messages for the handover procedure between the second fixed XDU 910-2 and the third fixed XDU 910-3 may be generated in the layer higher than the MAC layer (or, RLC layer). Also, in the handover procedure, the MAC layer function (or the MAC layer function and the RLC layer function) of the second fixed XDU 910-2, the third fixed XDU 910-3, and the second mobile XDU 920-2 may be newly configured after being reset.

Alternatively, when the second fixed XDU 910-2 and the third fixed XDU 910-3 include the physical layer (or, the physical layer and a part of the MAC layer), the control messages for the handover procedure between the second fixed XDU 910-2 and the third fixed XDU 910-3 may be generated in the MAC layer. Also, in the handover procedure, the MAC layer function (or, the MAC layer function and the RLC layer function) of the second fixed XDU 910-2, the third fixed XDU 910-3, and the second mobile XDU 920-2 may not be reset.

When the handover procedure between the second fixed XDU 910-2 and the third fixed XDU 910-3 is performed, identification information for identifying the second fixed XDU 910-2 and the third fixed XDU 910-3 may be transmitted to the second mobile XDU 920-2 by using the control message of the RRC layer, the control message of the MAC layer, or the like according to the hierarchical structure of the second fixed XDU 910-2 and the third fixed XDU 910-3. The identification information may include an identifier of the second fixed XDU 910-2, an identifier of the third fixed XDU 910-3, information on the reference signals, information on an allocated beam, and the like. Here, the information on the reference signals may include resources allocated for transmission of the reference signals, a sequence (e.g., index) of the reference signals, and the like. The information on the allocated beam may include a beam index, a transmission power, a width, a vertical angle, a horizontal angle, transmission and reception timings (e.g., indexes or offsets of subframe, slot, minislot, etc.), or the like. The second mobile XDU 920-2 may obtain the identification information through a control message of the RRC layer, a control message of the MAC layer, or the like, and perform a beam sweeping procedure, an access procedure, a packet transmission and reception procedure, and the like based on the obtained identification information.

Meanwhile, when a plurality of beams are configured for communications between the fixed XDUs 910-1, 910-2, and 910-3 and the mobile XDUs 920-1 and 920-2, at least one of the plurality of beams may be configured as reserved beams. For example, the plurality of beams may include a primary beam, a secondary beam, a reserved beam, and the like. The reserved beam may be referred to as a ‘candidate beam’. The communications (e.g., transmission and reception of packets) between the fixed XDUs 910-1, 910-2, and 910-3 and the mobile XDUs 920-1 and 920-2 may be performed by beams except the reserved beam (e.g., the primary beam and secondary beam). Each of the primary beam and the secondary beam capable of transmitting and receiving a packet may be referred to as an ‘active beam’ or ‘serving beam’, and the reserved beam may be referred to as an ‘inactive beam’ or ‘neighbor beam’.

The primary beam may be used for transmission and reception of control information and data, and the secondary beam may be used for transmitting and receiving data. Also, control information that can be transmitted and received via the secondary beam may be limited. For example, control information of a layer 1 (e.g., physical layer), control information of a layer 2 (e.g., MAC layer, RLC layer, PDCP layer) or control of a layer 3 (e.g., RRC layer) may be transmitted and received via the secondary beam. Also, control information for a specific function of each of the layers (e.g., layer 1, layer 2, and layer 3) may be transmitted and received via the secondary beam. Further, a specific type of control information may be transmitted and received via the secondary beam. Here, the specific type of control information may include control information for discontinuous transmission and reception operations (e.g., DRX operation, DTX operation), control information for retransmission operation, control information for connection establishment, control information for management operation, control information for measurement procedure, control information for reporting procedure, control information for paging procedure, control information for access procedure, and the like.

The reserved beam may be used for a beam switching procedure, a measurement procedure, a reporting procedure and the like. The measurement result for the reserved beam may be transmitted using the primary beam or the secondary beam. The measurement procedure and reporting procedure on the preliminary beam may be performed periodically or aperiodically based on preconfigured parameters, determination of the mobile XDU (e.g., when it is determined by the mobile XDU to meet the criteria preconfigured), and the like.

The reporting procedure of the measurement procedure and the reporting procedure of the beam sweeping procedure on the reserved beam may be performed through a control channel of the physical layer (e.g., a physical uplink control channel (PUCCH) of the LTE-based communication system), a control message of the MAC layer (e.g., a MAC control PDU of the LTE-based communication system), or the like. The result of the beam sweeping procedure may be the result of the sweeping procedure for the beam of the fixed XDU performed by the mobile XDU, and may be the result of the sweeping procedure for at least one beam (or beam group). The fixed XDU may obtain the result of the measurement procedure for the reserved beam from the mobile XDU, the result of the beam sweeping procedure, and the like, and may change a property (e.g., primary beam, secondary beam, or reserved beam) of the beam based on the obtained information.

The procedures for changing the property of the beam may include a procedure for changing from active beam to inactive beam, a procedure for changing from inactive beam to active beam, a procedure for changing from primary beam to secondary beam (or, reserved beam), a procedure for changing from secondary beam to primary beam (or, reserved beam), a procedure for changing from reserved beam to primary beam (or, secondary beam), and the like. The procedure for changing the property of the beam may be controlled by at least one layer of the MAC layer and the RRC layer of the XDU (e.g., fixed XDU).

When the procedure for changing the property of the beam is controlled by the MAC layer of the XDU, the MAC layer may inform the higher layer that the property of the beam has changed. Information indicating that the property of the beam has been changed may be transmitted to the mobile XDU through a control message of the MAC layer, a control channel of the physical layer (e.g., physical downlink control channel (PDCCH) in the LTE-based communication system, etc.). Meanwhile, the mobile XDU may request the fixed XDU to initiate the procedure for changing the property of the beam based on the measurement result on the beam, the result of the beam sweep procedure, and so on. In this case, the mobile XDU may transmit control information (or feedback information) requesting to start the procedure for changing the property of the beam through a control channel of the physical layer, a control message of the MAC layer, a control message of the RRC layer, or the like. The control message (e.g., control information, signaling information, feedback information) for the procedure for changing the property of the beam may include at least one information element among the information elements included in the allocated beam information described above.

Meanwhile, when a plurality of beams are allocated, a beam for transmitting a control channel of the physical layer among the plurality of beams may be configured. For example, the control channel of the physical layer may be transmitted through the primary beam (or secondary beam). Alternatively, the control channel of the physical layer may be transmitted through all of the beams. Here, the control channel of the physical layer may be a PDCCH, a PUCCH, or the like in the LTE-based communication system. The control channel of the physical layer may include scheduling information (e.g., radio resource allocation information, MCS index, etc.), a channel quality indicator (CQI), a precoding matrix indicator (PMI), feedback information (e.g., ACK, NACK according to HARQ operations), scheduling request (SR) information, results of the beam swapping procedure (e.g., beam index), measurement information of beams (e.g., active beams, inactive beams), and the like.

In the case that the control channel of the physical layer is configured to be transmitted from the fixed XDU to the mobile XDU using the primary beam, the mobile XDU may receive control information (e.g., feedback information) through the control channel of the physical layer of the primary beam, and perform a demodulation operation and a decoding operation on data received through the secondary beam based on the control information. In the case that the control channel of the physical layer is configured to be transmitted from the mobile XDU to the fixed XDU using the primary beam, the mobile XDU may use the control channel of the physical layer of the primary beam to transmit control information (e.g., SR information, feedback Information, etc.).

When a plurality of beams are allocated in the above-described multiple connection method, information on the plurality of allocated beams (e.g., beam indexes, interval between beams, information indicating whether contiguous beams are allocated, etc.) may be transmitted through a signaling procedure between the fixed XDU and the mobile XDU. Here, the information on the plurality of beams may be configured based on the movement speed, movement direction and the position of the mobile XDU, the radio channel quality (e.g., channel status indicator (CSI), RSSI, RSRP, RSRQ, etc.), or the like. The fixed XDU may obtain the movement speed, movement direction and position of the mobile XDU, the radio channel quality, or the like from the mobile XDU or another fixed XDU.

Meanwhile, the radio resource information described above may include frequency resource information (e.g., center frequency, system bandwidth, subcarrier, and the like) and time resource information (e.g., radio frame, subframe, TTI, slot, minislot, symbol, etc.). Also, the radio resource information may include a hopping pattern, beam configuration information (e.g., beamforming information, beam index, beam width), a code sequence (e.g., bit stream, signal stream), or the like. The type of the resource (e.g., physical channel or transport channel) indicated by the radio resource information may vary according to a property (e.g., type) of a packet, a transmission scheme (e.g., uplink transmission, downlink transmission, or sidelink transmission), or the like.

Sector Changing Method in Xhaul Network

Next, a method of changing a sector in an Xhaul network will be described.

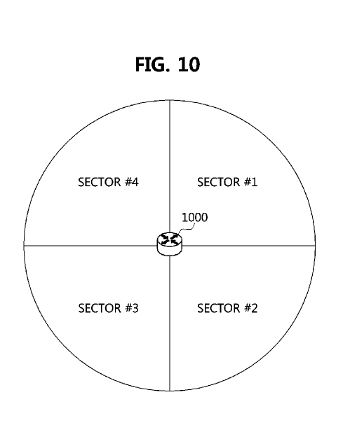

FIG. 10 is a conceptual diagram illustrating a first embodiment of an XDU forming a plurality of sectors.

Referring to FIG. 10, a first XDU 1000 belonging to an Xhaul network may form a plurality of sectors (e.g., sector #1, sector #2, sector #3 and sector #4), and provide communication services to a second XDU (not shown), a third XDU (not shown), a base station (not shown), and the like. The sector may be referred to as a ‘cell’, and may correspond to a beam generated by the first XDU 1000.

For example, when a base station connected to and cooperating with the first XDU 1000 receives communication services from the second XDU by establishing a link with the second XDU through the sector #1, and receives communication services from the third XDU by establishing a link with the third XDU through the sector #3, the first XDU 1000 may transmit a packet received from the second XDU belonging to the sector #1 to the base station through the sector #3, and may transmit a packet received from the base station belonging to the sector #3 to the second XDU through the sector #1 instead of the third XDU of the sector #3. In the Xhaul network, communications through a sector may be controlled by an XDU or an XCU forming the sector.

In the case where a packet is transmitted through a change between sectors formed by the first XDU 1000 connected to and cooperating with the base station, a path change procedure (e.g., path reconfiguration procedure) may be performed before or after transmitting the packet by the sector change. A control message for the path change procedure (e.g., path reconfiguration procedure) in accordance with the sector change in the first XDU 1000 may be transmitted to the XCU, the XDU, the XDU sector, the base station, the terminal (e.g., the terminal receiving communication services from the base station), and the like.

The first XDU 1000 may provide communication services using at least one sector among all the sectors (e.g., sector #1, sector #2, sector #3, and sector #4). In addition, the sector used by the first XDU 1000 may be changed. That is, when the sector to which the second XDU belongs is changed due to the movement of the second XDU communicating with the first XDU 1000, the sector used by the first XDU 1000 may be changed. For example, the first XDU 1000 may provide communication services to the second XDU using the sector #1 when the second XDU belongs to the sector #1 in a time interval #1, and may provide communication services to the second XDU using the sector #2 when the sector to which the second XDU belongs is changed from the sector #1 to the sector #2 in a time interval #2 after the time interval #1. Accordingly, the first XDU 1000 can support the mobility of the second XDU. Here, a sector currently used by the first XDU 1000 may be referred to as a ‘serving sector’, and a sector to be used as a serving sector may be referred to as a ‘target sector’.

Before the sector used by the first XDU 1000 is changed, a path configuration procedure for the target sector (e.g., a path configuration procedure with the second XDU belonging to the target sector) may be performed. Alternatively, when the path configuration procedure for the target sector is completed but the state of the Xhaul link between the first XDU 1000 and the second XDU belonging to the target sector is in an inactive state, a procedure of activating the Xhaul link may be performed.

In the communication between the first XDU 1000 and the second XDU, the sector change procedure may be performed as follows. The second XDU may belong to at least one sector among the sectors formed by the first XDU 1000.

1) The second XDU may perform a monitoring operation (e.g., a radio resource management (RRM) operation) for the plurality of sectors of the first XDU 1000. For example, the second XDU may receive a signal (e.g., a discovery signal, a reference signal, a control signal, etc.) from each of the plurality of sectors of the first XDU 1000, measure channel qualities in the plurality of sectors, and manage information on the measured channel qualities.

2) The second XDU may compare the measured channel quality with a preset reference. When a strength (hereinafter, ‘first signal strength’) of a signal received for the serving sector of the first XDU 1000 is equal to or less than a predetermined threshold, a strength (hereinafter, ‘second signal strength’) of a signal received for a sector other than the serving sector among the sectors of the first XDU 1000 exceeds a predetermined threshold, or a difference between the first signal strength and the second signal strength is equal to or greater than a predetermined threshold, the second XDU may trigger the sector change procedure. Also, the second XDU may start a timer TSS for stopping the sector change procedure.

3) The second XDU triggering the sector change procedure may transmit to the first XDU 1000 a change request message including information indicating the start of the sector change procedure, configuration information of the target sector, and the like. The configuration information of the target sector may indicate a sector from which a signal exceeding a predetermined threshold is received among the sectors of the first XDU 1000. The first XDU 1000 may receive the change request message from the second XDU, and identify the information included in the received change request message. Also, the first XDU 1000 may transmit a change request message to the XCU. Upon receiving the change request message, the XCU may confirm that the sector change procedure for the first XDU 1000 is performed and may support the execution of the sector change procedure.

4) The first XDU 1000 may store a packet to be transmitted to the second XDU in a buffer for the target sector indicated by the change request message. For example, the first XDU 1000 may include a buffer for the serving sector, a buffer for the target sector, and the like, and when the change request message is received, the packet to be transmitted to the second XDU, which is stored in the buffer for the serving sector, may be forwarded to the buffer for the target sector. Here, the packet forwarding procedure may be omitted. Meanwhile, when a message related to a handover procedure (e.g., handover request message, handover complete message, etc.) is received at the first XDU 1000 or the second XDU before expiration of the TSS, the sector change procedure may be stopped. When a message related to a handover procedure (e.g., handover request message, handover complete message, etc.) is received at the first XDU 1000 or the second XDU after expiration of the TSS, the handover procedure may be performed independently from the sector change procedure.

5) The first XDU 1000 may set the target sector indicated by the change request message to a new serving sector, and may transmit the packet to the second XDU using the new serving sector. The second XDU may receive the packet from the first XDU 1000 via the new serving sector.

6) Meanwhile, the second XDU 1000 may perform a monitoring operation (e.g., RRM operation) on the plurality of sectors of the first XDU 1000, and may perform a sector resuming procedure for the previous serving sector when a strength of signals received from the previous serving sector is equal to or greater than a predetermined threshold. For example, the second XDU may generate a resume request message including information instructing to resume communications with the previous serving sector of the first XDU 1000, configuration information of the previous serving sector (e.g., information indicating the previous serving sector), and the like, and transmit the resume request message to the first XDU 1000.

7) The first XDU 1000 may receive the resume request message from the second XDU, and confirm the information included in the received resume request message. Also, the first XDU 1000 may transmit a resume request message to the XCU. Upon receiving the resume request message, the XCU may confirm that the sector resuming procedure for the previous serving sector of the first XDU 1000 is performed and mat support execution of the sector resuming procedure. The first XDU 1000 may transmit a packet to the second XDU using the previous serving sector indicated by the resume request message instead of the current serving sector. The second XDU may receive the packet from the first XDU 1000 via the previous serving sector.

Method for Supporting Mobility of Terminal in Access Network

The mobility support procedure for the mobile XDU in the Xhaul network described above (e.g., the mobility support procedure shown in FIG. 6) may be applied to the access network. For example, the mobility support procedure for the mobile XDU may be used for the terminal belonging to the access network. In this case, the base station (e.g., macro base station, small base station, RRH, TRP, etc.) may perform functions of a serving XDU, a linked XDU, a target XDU, a candidate linked XDU, a candidate target XDU, or the like, and the terminal may perform functions of a mobile XDU above described. The function of the XCU may be performed by an entity that performs RRC functions, an MME, or the like in the LTE-based communication system.

For example, the terminal may establish connections with a plurality of base stations. Each of the plurality of base stations connected to the terminal may store and manage context information (e.g., RRC context information, AS context information, and AS configuration information) of the terminal. The context information of the terminal may include an identifier and capacity information of the terminal, an identifier of the serving base station, encryption information, and the like. The plurality of base stations may support different RATs, different protocol layers (e.g., layer 1, layer 2, layer 3), and the like. Also, the plurality of base stations may be located at different places.

Among the plurality of base stations connected to the terminal, a serving base station may provide communication services to the terminal. A linked base station among the plurality of base stations may not be able to provide communication services to the terminal since resources for an access link between the linked base station and the terminal are not allocated (e.g., the access link is in an inactive state). Alternatively, the linked base station may provide communication services to the terminal under limited conditions.

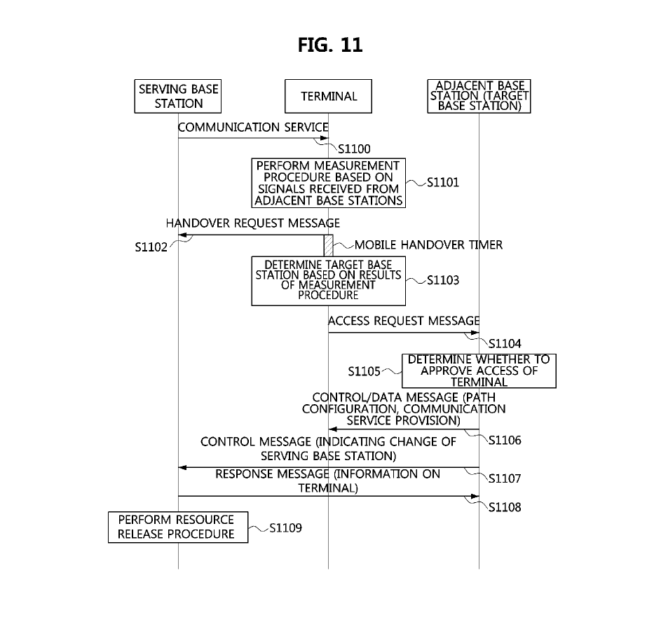

FIG. 11 is a sequence chart illustrating a first embodiment of a mobility support method of a terminal in the integrated communication system.

Referring to FIG. 11, a terminal may be connected to a serving base station, and the serving base station may provide communication services to the terminal (S1100). The terminal connected to the serving base station may receive signals from at least one adjacent base station and may perform a measurement procedure for at least one adjacent base station based on the received signals (S1101). For example, the terminal may measure qualities (e.g., received signal strength, latency, BLER) of radio channels between the terminal and at least one adjacent base station, and determine whether to perform a handover procedure based on the measurement results. When the strength of the signal received from the adjacent base station satisfies a preset reference value (e.g., the signal strength of the serving base station) or when a difference between the signal strength of the adjacent base station and the signal strength of the serving base station satisfies a preset reference condition, the terminal may determine to perform the handover procedure. The control parameters needed for performing the measurement procedure may be configured by the serving base station, and the serving base station may inform the terminal of the configured control parameters. The control parameters may include information of the adjacent base station (e.g., operating frequency, identifier, type, version, etc.), information on radio resources allocated for the terminal, and the like.

When it is determined that the handover procedure is to be performed, the terminal may generate a handover request message requesting execution of the handover procedure, and transmit the generated handover request message to the serving base station (S1102). Also, the terminal may set a mobile handover timer for triggering a handover procedure controlled by the terminal (hereinafter referred to as a ‘mobile handover procedure’), and start the mobile handover timer at the transmission time of the handover request message. In the case that the response to the handover request message is not received from the serving base station until expiration of the mobile handover timer, the terminal may initiate the mobile handover procedure. Alternatively, the mobile handover procedure may be initiated when a handover related message is not received from a target base station determined by the serving base station. Also, when a start condition of the mobile handover procedure is satisfied before the response message to the handover request message is received from the serving base station after the handover request message is transmitted, the mobile station may initiate the mobile handover procedure. For example, the start condition of the mobile handover procedure may be ‘when the radio channel quality of the serving base station is lower than a preset reference value and the radio channel quality of the adjacent base station (or the target base station) is better than a preset reference value’. As described above, the start condition of the mobile handover procedure may be configured based on the mobile handover timer, the reference value of radio channel quality of the serving base station, the reference value of radio channel quality of the adjacent base station (or the target base station), and the like.

The terminal may receive a handover response message from the serving base station in response to the handover request message. The handover response message may include configuration information of the target base station determined by the serving base station. The handover response message may be a control message (e.g., a handover command message, a connection reconfiguration message, or the like) indicating execution of the handover. The connection reconfiguration message may include mobility control information. The mobility control information may include an identifier of the target base station, configuration information and encryption information for an access procedure between the target base station and the terminal, parameters configured for the mobile handover procedure, beamforming information (e.g., configuration information of a transmission beam, configuration information of a reception beam, and the like). The parameters configured for the mobile handover procedure may include a mobile handover timer for triggering the mobile handover procedure, a threshold used for determination of the target base station, a priority of each of candidate target base stations belonging to a candidate target base station list, or the like.

The terminal may perform the handover procedure with the target base station indicated by the handover response message. For example, the terminal may transmit an access request message to the target base station. Also, the terminal may set a mobile handover timer (e.g., the timer included in the handover response message) that triggers the mobile handover procedure and may initiate the mobile handover timer at the time of transmission of the access request message. When the response to the access request message is not received from the target base station before expiration of the mobile handover timer, or when the handover procedure between the terminal and the target base station has not been successfully completed, the terminal may initiate the mobile handover procedure. A new target base station may be determined by the terminal in the mobile handover procedure.

Meanwhile, in the case that the mobile handover procedure is initiated, the terminal may select a target base station among adjacent base stations based on the result of the measurement procedure performed in the step S1101, whether or not the mobile handover procedure is supported, load status information of the adjacent base stations, and the like (S1103). Here, ‘whether or not the mobile handover procedure is supported’ may be the same parameter as the above-described information indicating whether or not the mobile XDU based target XDU determination procedure is supported or the information on whether or not the mobile handover procedure is allowed. The base station may inform the terminal of whether to support the mobile handover procedure using common control information (e.g., system information) or a separate signaling message.

For example, when the signal strength received from the adjacent base station is greater than the signal strength received from the serving base station (or if the difference between the signal strength received from the adjacent base station and the signal strength received from the serving base station is greater than a predetermined threshold), when the adjacent base station supports the mobile handover procedure and the load status of the adjacent base station satisfies a predetermined criterion, or when the selection criteria of the target base station predefined in the integrated communication system are satisfied, the terminal may determine the corresponding adjacent base station as the target base station.

The load status information may be identified based on control messages (e.g., messages including dedicated control information, messages including common control information), system information, etc. obtained from adjacent base stations. The load status information may be represented by a ratio of radio resources currently used by the adjacent base station to entire radio resources of the adjacent base station, or a ratio of available radio resources of the adjacent base station to entire radio resources of the adjacent base station. Alternatively, the mapping relationship between load statuses and specific indexes (or priorities) may be preset, and information on the preset mapping relationship may be shared by communication nodes (e.g., base stations, terminals, etc.) belonging to the access network. Accordingly, the load status information may be signaled using a specific index (or priority) that is mapped to a current load status.

A random access procedure between the terminal and the target base station (e.g., the adjacent base station determined as the target base station) may be performed. Meanwhile, in the step S1103, a plurality of adjacent base stations may be determined as the target base stations. In this case, the terminal may perform path configuration procedures with the plurality of adjacent base stations, and may perform a random access procedure with one adjacent base station among the plurality of adjacent base stations paths of which are configured with the terminal. Control parameters needed for performing the random access procedure may be configured by the serving base station, and the serving base station may inform the terminal of the configured control parameters. The control parameters may include information of the adjacent base station (e.g., operating frequency, identifier, type, version, etc.), information on radio resources allocated for the terminal, and the like.

In the random access procedure, the terminal may transmit an access request message (e.g., a random access preamble) to the target base station (S1104). The access request message may be transmitted through a predetermined uplink resource. The access request message may include information on the serving base station (e.g., the identifier of the serving base station, a time the terminal has stayed at the serving base station), and information on the terminal (e.g., an identifier of the terminal (e.g., a temporary mobile subscriber identity (TMSI), a C-RNTI assigned by the target base station, etc.), movement status information of the terminal (e.g., movement speed, movement direction, movement path, position information, etc.), capability information, information on communication services requested by the terminal (or, information on communication services provided to the terminal), a result of the measurement procedure (e.g., the measurement procedure in the step S1101), and the like.

In order to increase the efficiency of the step S1104, a plurality of uplink beams may be allocated to the terminal. The serving base station may transmit a handover response message including allocation information on the plurality of uplink beams (e.g., resource allocation information of a plurality of random access preambles). The terminal may transmit the access request message to the target base station using the plurality of uplink beams indicated by the handover response message. Alternatively, even when a plurality of uplink beams are not allocated to the terminal, the terminal may transmit the access request message to the target base station using a plurality of uplink beams. Also, the target base station may allocate a plurality of uplink beams to the terminal. In this case, the terminal may transmit a handover related message, data, and the like to the target base station using the plurality of uplink beams.

The target base station may receive the access request message from the terminal and identify the information included in the access request message. The target base station may determine whether or not to allow the access of the terminal based on the access request message (S1105). In the case that the terminal is allowed to access the target base station, the target base station may transmit a control message (or, data message) for configuration of a path (or communication service provision) to the terminal (S1106). Also, when a plurality of adjacent base stations are determined as the target base stations, and the path configuration between the terminal and the plurality of adjacent base stations is completed in the step S1103, the target base station may transmit a control message (or, data Message) to the plurality of adjacent base stations. The terminal may receive the control message (or, data message) from the target base station in response to the access request message, and may determine that the terminal is allowed to access the target base station based on the received control message (or data message).

Also, the target base station may generate a control message including information on the terminal, information indicating that the serving base station has been changed, and the like, and may transmit the generated control message to the serving base station (S1107). The serving base station may receive the control message from the target base station, and identify that the serving base station of the terminal has been changed based on the received control message. In this case, the serving base station may generate a response message including the movement status information, capability information, communication service information, context information, and the like of the terminal, and transmit the generated response message to the target base station (S1108). Also, the serving base station may release the radio resources allocated for the terminal (S1109), and delete the information (e.g., context information) of the terminal after a preset time. The serving base station may receive the response message from the target base station and confirm the information included in the response message.

Mobility Support Method by a Plurality of Base Stations

Meanwhile, when a single base station performs control functions for the terminal (e.g., RRC connection control and management functions in the LTE-based communication system), the performance of the integrated communication system may deteriorate due to an interruption or failure of the handover procedure. In the methods described below, the base station may be a fixed XDU of an Xhaul network and the terminal may be a mobile XDU of the Xhaul network.

In order to prevent performance degradation of the integrated communication system due to interruption or failure of the handover procedure, a plurality of base stations may perform control functions for the terminal. For example, the terminal may establish connections with a plurality of base stations (e.g., a first base station and a second base station), and an RRC function block (e.g., an entity perform the RRC function) of each of the plurality of base stations may perform a connection control function. Specifically, the terminal may establish a connection with the first base station, and in the connection configuration procedure between the terminal and the second base station, a control message including first connection configuration control information configured by the RRC function block of the first base station may be transmitted to the second base station. The first connection configuration control information may include configuration information of a DRX function, configuration information for a measurement procedure, configuration information for a reporting procedure, bearer configuration information, radio resource allocation information (e.g., channel configuration information), scheduling identifier allocation information, configuration information of beam forming, configuration information of the AS, or the like.

The second base station may receive the control message including the first connection configuration control information from the terminal and may configure second connection configuration control information between the terminal and the second base station based on the information included in the control message. The second connection configuration control information may be configured by an RRC function block of the second base station and the second base station may transmit the control message including the second connection configuration control information to the terminal. The terminal may receive the second connection configuration control information from the second base station.

Since the terminal is connected to the plurality of base stations, there may be a base station controlling the terminal even when the terminal moves. Accordingly, a ping pong problem can be reduced in the handover procedure, and the possibility of transmission and reception failure of the handover related message can be reduced. The plurality of base stations connected to the terminal may support different RATs. For example, the first base station may support 4G communication technology (e.g., LTE communication technology, LTE-A communication technology) and the second base station may support 5G communication technology (or radio access technology using license-exempt bands (e.g., WLAN technology)). In this case, the terminal may independently perform a control signaling procedure for a radio link (e.g., bearer) established based on the RAT supported by each of the plurality of base stations, for each of the plurality of base stations.

When data of the terminal is transmitted through the plurality of base stations, a reordering operation (e.g., a reassembling operation) of the data may be performed by one base station among the plurality of base stations. The reordering operation (e.g., reassembling operation) of the data may be performed by a PDCP layer of the base station (or an upper layer (e.g., adaptation layer) than the PDCP layer). Thus, the plurality of base stations may forward the data received from the terminal to the base station performing the reordering operation (e.g., reassembling operation). When the connections between the terminal and other base station except the first base station among the plurality of base stations are released, the first base station may perform the reordering operation (e.g., a reassembling operation). However, if the first base station does not support the reordering operation (e.g., reassembling operation), a procedure for changing the base station supporting the reordering operation may be performed. The procedure for changing the base station supporting the reordering operation (e.g., reassembling operation) may be performed within a connection release procedure between the terminal and the base station. Alternatively, the procedure of changing the base station supporting the reordering operation (e.g., reassembling operation) may be performed before or after the connection release procedure between the terminal and the base station is performed.

Meanwhile, the plurality of base stations connected to the terminal may be classified into a primary base station (e.g., a master base station, an anchor base station), a secondary base station (e.g., a slave base station), and the like. For example, a base station that is first connected to the terminal may be set as the primary base station. Alternatively, the primary base station may be determined in a connection procedure between the terminal and the second base station. Among the plurality of base stations connected to the terminal, the remaining base stations other than the primary base station may be set as the secondary base stations. Alternatively, the primary base station may be selected by the terminal. For example, the terminal may select a preferred RAT and may transmit information on the preferred RAT to a communication node responsible for determining the primary base station in the integrated communication system. The communication node may determine the primary base station based on the information on the preferred RAT received from the terminal.

Each of the primary base station and the secondary base station may independently perform a connection control function for the terminal. The secondary base station may restrictively perform the connection control function for the terminal. For example, the secondary base station may perform limited connection control functions (e.g., some of all connection control functions configured for the communication system) as compared to the primary base station. Alternatively, when the predetermined criteria are satisfied, the secondary base station may perform the connection control function. The primary base station may perform a reordering function (e.g., reassembling function).

The procedures and methods proposed according the present invention may be applied to base stations and terminals of the access network, which respectively correspond to the fixed XDUs and the mobile XDUs. For example, a mechanism applied to the mobile XDU (e.g., path configuration, beam sweeping, beam allocation, mobility control, etc.) may be applied to a radio access network (RAN) between the base station and the terminal. Also, each of the base stations may use a different RAT, may be located in a different geographical location, and may support different communication protocol layers.

Regarding the operation of the timer described in the present invention, even though operations such as start, stop, reset, restart, and expire of the timer are not described separately, each operation may mean an operation of the corresponding timer.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

1. An operation method of a mobile communication node having mobility in an Xhaul network supporting communications between a core network and an access network, the operation method comprising:
measuring a channel quality between the mobile communication node and at least one adjacent communication node based on a signal received from the at least one adjacent communication node;
transmitting a report message including information on the channel quality to a serving communication node connected to the mobile communication node;
receiving, from the serving communication node, a response message including configuration information of a target communication node determined based on the report message; and
performing a connection configuration procedure with the target communication node indicated by the response message,
wherein the mobile communication node, the serving communication node, the at least one adjacent communication node, and the target communication node belong to the Xhaul network, and the target communication node is one of the at least one adjacent communication node.

2. The operation method according to claim 1, wherein the core network comprises a serving gateway (S-GW), a packet data network (PDN) gateway (P-GW), and a mobility management entity (MME), the access network includes a terminal and a base station, the Xhaul network includes a plurality of communication nodes, the plurality of communication nodes are connected via radio links, a first communication node of the plurality of communication nodes is connected with at least one of the S-GW and the MME, and a second communication node of the plurality of communication nodes is connected to the base station.

3. The operation method according to claim 1, wherein the signal received from the at least one adjacent communication node is a discovery signal, a synchronization signal, or a control signal.

4. The operation method according to claim 1, wherein the report message includes configuration information of at least one candidate target communication node determined based on the information on the channel quality, and the target communication node is determined among the at least one candidate target communication node.

5. The operation method according to claim 1, wherein the configuration information of the target communication node includes information on a resource used for communications between the mobile communication node and the target communication node and an identifier of the target communication node.

6. The operation method according to claim 1, wherein context information of the mobile communication node is managed by the target communication node when the connection configuration procedure between the mobile communication node and the target communication node is completed, and the context information includes information on communication services requested by the mobile communication node, and an identifier and capability information of the mobile communication node.

7. The operation method according to claim 1, further comprising:
determining the target communication node based on the information on the channel quality when the response message is not received within a predetermined time; and
performing the connection configuration procedure with the target communication node determined by the mobile communication node.

8. The operation method according to claim 1, further comprising:
performing a connection release procedure between the mobile communication node and the serving communication node, when the connection configuration procedure between the mobile communication node and the target communication node is completed.

9. An operation method of a serving communication node connected to a mobile communication node in an Xhaul network supporting communications between a core network and an access network, the operation method comprising:
receiving, from the mobile communication node, a report message including information on a channel quality between the mobile communication node and at least one adjacent communication node;
determining a target communication node based on the information on the channel quality;
transmitting a mobility request message requesting mobility support of the mobile communication node to the target communication node; and
transmitting a response message including configuration information of the target communication node to the mobile communication node, when a mobility approval message indicating approval of the mobility support of the mobile communication node is received from the target communication node,
wherein the mobile communication node, the serving communication node, the at least one adjacent communication node, and the target communication node belong to the Xhaul network, and the target communication node is one of the at least one adjacent communication node.

10. The operation method according to claim 9, wherein the report message includes configuration information of at least one candidate target communication node determined based on the information on the channel quality, and the target communication node is determined among the at least one candidate target communication node.

11. The operation method according to claim 9, wherein the mobility request message includes information on communication services requested by the mobile communication node, and an identifier and capability information of the mobile communication node.

12. The operation method according to claim 9, wherein the configuration information of the target communication node includes information on a resource used for communications between the mobile communication node and the target communication node and an identifier of the target communication node.

13. The operation method according to claim 9, wherein the response message instructs the mobile communication node to execute a handover from the serving communication node to the target communication node.

14. The operation method according to claim 9, further comprising:
performing a connection release procedure between the mobile communication node and the serving communication node, when the connection configuration procedure between the mobile communication node and the target communication node is completed.

15. A mobile communication node having mobility in an Xhaul network supporting communications between a core network and an access network, the mobile communication node comprising a processor and a memory storing at least one instruction executed by the processor, wherein the at least one instruction is configured to:
measure a channel quality between the mobile communication node and at least one adjacent communication node based on a signal received from the at least one adjacent communication node;
transmit a report message including information on the channel quality to a serving communication node connected to the mobile communication node;
receive, from the serving communication node, a response message including configuration information of a target communication node determined based on the report message; and
perform a connection configuration procedure with the target communication node indicated by the response message,
wherein the mobile communication node, the serving communication node, the at least one adjacent communication node, and the target communication node belong to the Xhaul network, and the target communication node is one of the at least one adjacent communication node.

16. The mobile communication node according to claim 15, wherein the report message includes configuration information of at least one candidate target communication node determined based on the information on the channel quality, and the target communication node is determined among the at least one candidate target communication node.

17. The mobile communication node according to claim 15, wherein the configuration information of the target communication node includes information on a resource used for communications between the mobile communication node and the target communication node and an identifier of the target communication node.

18. The mobile communication node according to claim 15, wherein context information of the mobile communication node is managed by the target communication node when the connection configuration procedure between the mobile communication node and the target communication node is completed, and the context information includes information on communication services requested by the mobile communication node, and an identifier and capability information of the mobile communication node.

19. The mobile communication node according to claim 15, wherein the at least one instruction is further configured to:
determine the target communication node based on the information on the channel quality when the response message is not received within a predetermined time; and
perform the connection configuration procedure with the target communication node determined by the mobile communication node.

20. The mobile communication node according to claim 15, wherein the at least one instruction is further configured to perform a connection release procedure between the mobile communication node and the serving communication node, when the connection configuration procedure between the mobile communication node and the target communication node is completed.
